(19) United States
(12) Patent Application Publication
(10) Pub. No.: US 2026/0261422 A1
(43) Pub. Date: Sep. 3, 2026

(54) BEICHIP / BEILOGIC TRUSTED-EXECUTION SYSTEM FOR BEHAVIORAL ECONOMIC IDENTITY, TIME-VALUE ANCHORING, DOMAIN-NODE PROVISIONING, ASSET-STATE AUTHORIZATION, AND BOUNDED ROLLBACK

(71) Applicant: FURONG BEI, San Gabriel, CA (US)

(72) Inventor: FURONG BEI, San Gabriel, CA (US)

(21) Appl. No.: 19/687,086

(22) Filed: May 26, 2026

(51) Int. Cl. H04L 9/32

(52) U.S. Cl. CPC H04L 9/3234

(57) ABSTRACT

A BEIChip/BEILogic trusted-execution system binds a behavioral event envelope, an identity anchor, and a trusted time anchor within a hardware security module, trusted execution environment, secure element, cloud enclave, or software-defined chip. A nonce-protected TimeChip includes an event digest, identity reference, trusted-time reference, validity window, policy hash, TimeFlux weighting vector, rollback boundary pointer, audit pointer, and cryptographic signature. A BEILogic state machine applies identity, time, behavior, policy, anti-replay, mapping, medical-admission, namespace-provisioning, endpoint-classification, and compliance checks before producing a signed BEI asset-state record. Domain-node asset plots, rooted cellular endpoint networks, signed endpoint records, PUFShield attestation, configurable mapping tables, Green Flux evidence, BEI Node provisioning, and medical-health gate embodiments support minting, indexing, exchange, authorization, compliance, namespace provisioning, industry adapters, and bounded rollback through chip-attested PUFShield verification and signed BEI asset-state records.

### CROSS-REFERENCE TO RELATED APPLICATIONS

This application may claim the benefit of, be related to, or be filed in connection with selected prior-filed applications identified in the Application Data Sheet, including any continuation, continuation-in-part, divisional, national-stage, or bypass-continuation relationships properly set forth therein.

The present application is commonly invented and commonly owned with a plurality of pending United States patent applications directed to behavioral-economic identity, trusted time-value records, BEIChip and BEILogic trusted execution, PUFShield attestation, domain-node namespace provisioning, medical admission gates, asset-time-monetary clearing, exchange, minting, indexing, resource evidence, and bounded rollback records.

This application claims benefit only of prior-filed applications expressly identified in the Application Data Sheet. Other commonly invented and commonly owned applications, domain-rooted implementation materials, protocol materials, product-interface materials, domain-name endpoint materials, or technical design materials are referenced only as related technical subject matter unless separately identified as a priority or domestic benefit claim in the Application Data Sheet.

### TECHNICAL FIELD

The disclosure relates to trusted computing, secure identity binding, behavioral-event verification, domain-node provisioning, cryptographic signing, machine-readable receipts, trusted time-value anchoring, rollback-boundary control, and secure cross-system authorization.

More particularly, the disclosure relates to a BEIChip/BEILogic system that binds a behavioral event envelope, identity anchor, trusted time reference, nonce state, policy hash, rollback boundary, and signed asset-state record within a trusted execution module such as a secure element, trusted execution environment, hardware security module, trusted platform module, secure enclave, cloud enclave, software-defined BEPU, or equivalent trusted execution boundary.

The technical field further includes anti-replay protocols, idempotency keys, PUF-based device attestation, monotonic-counter verification, append-only audit records, namespace provisioning state machines, medical admission gates, and environment or energy signal weighting for resource-related behavioral records.

### BACKGROUND

Conventional Internet systems commonly treat a domain name as a routing address. A typical chain is domain name, website, content, traffic, advertising, and sales. Such systems do not provide a chip-authenticated domain-node asset plot carrying a signed endpoint record, configurable mapping table, provisioning state, idempotency state, rollback record, and downstream authorization interface.

Conventional identity systems verify user credentials, wallet addresses, biometric identifiers, or device certificates. They do not provide a unified trusted-execution pathway that binds an identity subject, behavioral event, trusted time reference, policy container, TimeFlux weighting vector, rollback boundary, and signed asset-state record before changing minting, indexing, exchange, medical, provisioning, or compliance state.

Conventional secure enclave, HSM, TEE, TPM, wallet, and cloud enclave systems protect keys and may sign data. They generally do not execute a behavioral-economic identity state machine configured to evaluate identity validity, behavior validity, time validity, policy validity, replay status, mapping state, medical admission state, provisioning state, and rollback boundary state in one deterministic sequence.

Conventional immutable ledgers preserve entries, but many do not provide a bounded rollback mechanism that preserves the original record while enabling authorized correction, freeze, reverse clearing, clawback, re-minting, re-indexing, or remediation through a tamper-evident rollback boundary.

There is a need for an audit-preserving correction path that does not rely on arbitrary deletion. There is also a need for a machine-readable record that can be accepted by downstream systems without requiring those downstream systems to be co-operators of the trusted execution infrastructure.

There is a need for a concrete and verifiable trusted-execution infrastructure deployable in personal devices, medical terminals, domain-node routers, IoT gateways, HSM servers, cloud enclaves, and software-defined secure execution services, while producing uniform signed records for downstream systems.

There is a further need for a practical system capable of supporting medical-health events, domain-node provisioning events, green-energy or resource contribution events, and ordinary service receipts without reducing the technology to a mere accounting or business method.

### SUMMARY

In one aspect, a method is performed within an HSM or TEE comprising a monotonic counter, PUF root-of-trust circuit, and hardware-isolated key slot. The method receives a behavioral event envelope, binds the envelope to a trusted time anchor, records a current monotonic counter value associated with the trusted time anchor, generates a nonce-protected time-value fragment, executes BEILogic inside the trusted execution boundary, and outputs a signed BEI asset-state record containing a rollback boundary field, eligibility flags, BEILogic decision code, audit pointer, and cryptographic signature.

In another aspect, a chip-authenticated domain-node network security infrastructure includes domain-node asset plots, signed endpoint records, a BEI Access Point, chip-authentication module, signed endpoint resolver, namespace provisioning state machine, memory-mapped configurable mapping table, authorization ledger, and output interface to at least one downstream system.

In another aspect, a BEI hardware-software chip apparatus includes an identity-binding module and secure memory storing a cryptographic identity anchor, monotonic counter, nonce cache, policy hash register, state transition table, and rollback boundary register. The apparatus includes a PUF root-of-trust circuit, event input buffer, trusted execution module, BEILogic engine, cryptographic signing module, and signature output serializer.

The disclosed system improves computer security and trusted authorization by requiring event data to pass through identity binding, trusted time binding, nonce validation, policy validation, mapping validation, rollback-boundary control, and signature generation before any downstream state is changed.

The system can be implemented in a local hardware chip, mobile secure element, HSM-backed server, cloud enclave, software-defined BEPU, IoT gateway security module, medical device controller, domain-node router, wallet device, or edge provisioning node. These implementation paths preserve the same technical chain of event input, trusted execution, state determination, signature, audit, and bounded rollback.

### BRIEF DESCRIPTION OF THE DRAWINGS

FIG. 1 illustrates overall BEIChip/BEILogic trusted-execution system architecture.

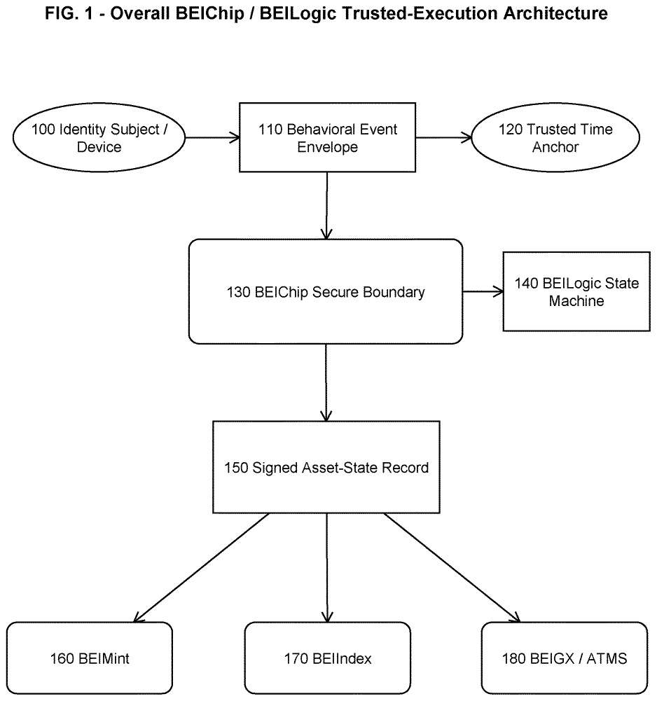

FIG. 2 illustrates trusted time-value anchoring and TimeFlux flow.

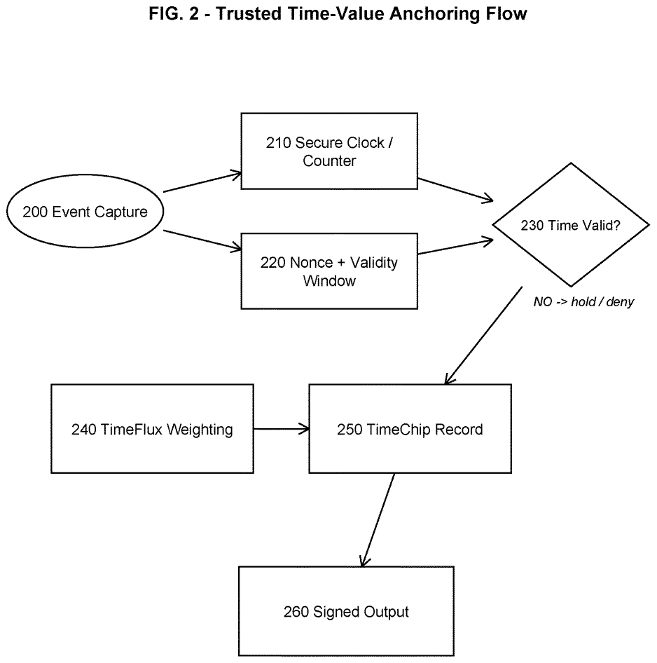

FIG. 3 illustrates TimeChip/time-value fragment data structure.

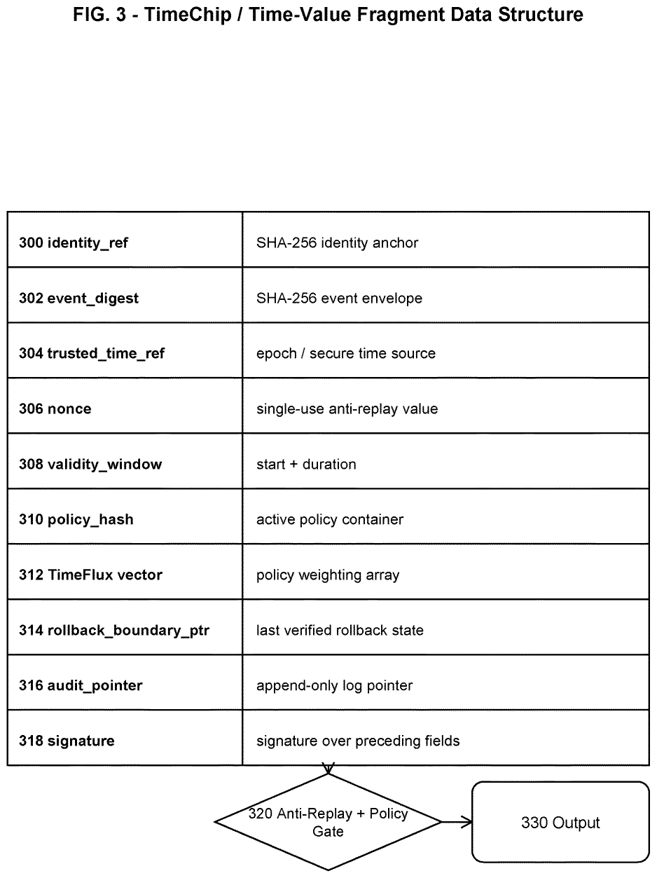

FIG. 4 illustrates BEI hardware-software chip apparatus.

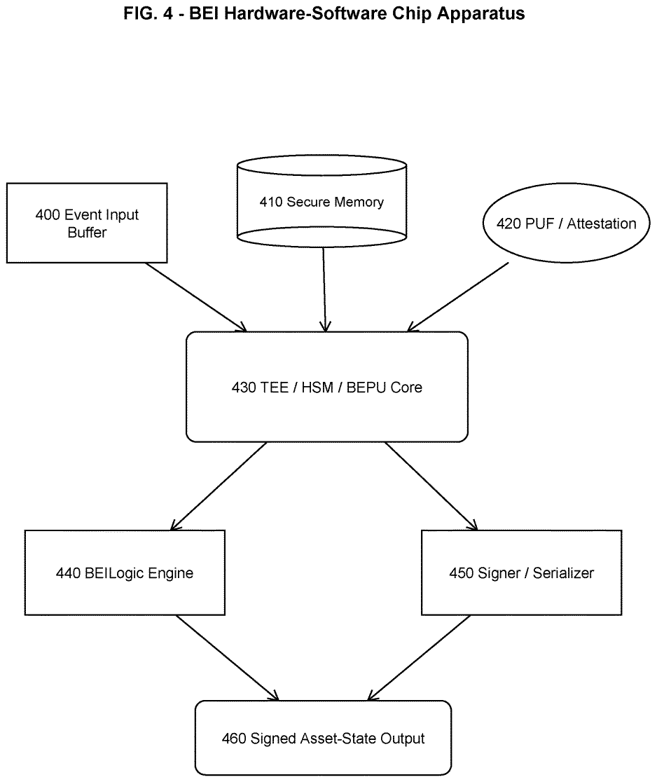

FIG. 5 illustrates PUFShield/TEE/HSM/secure execution boundary.

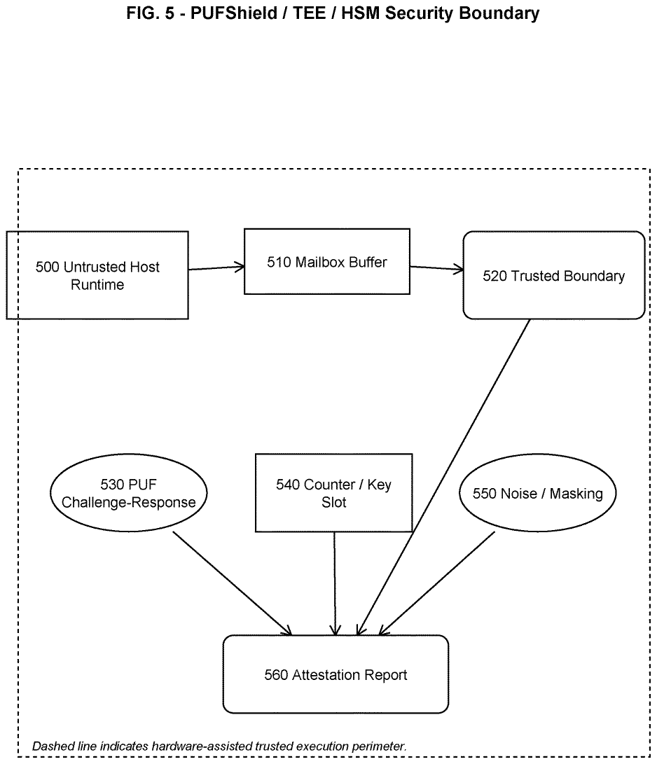

FIG. 6 illustrates BEILogic rule engine and TRAM weighting model.

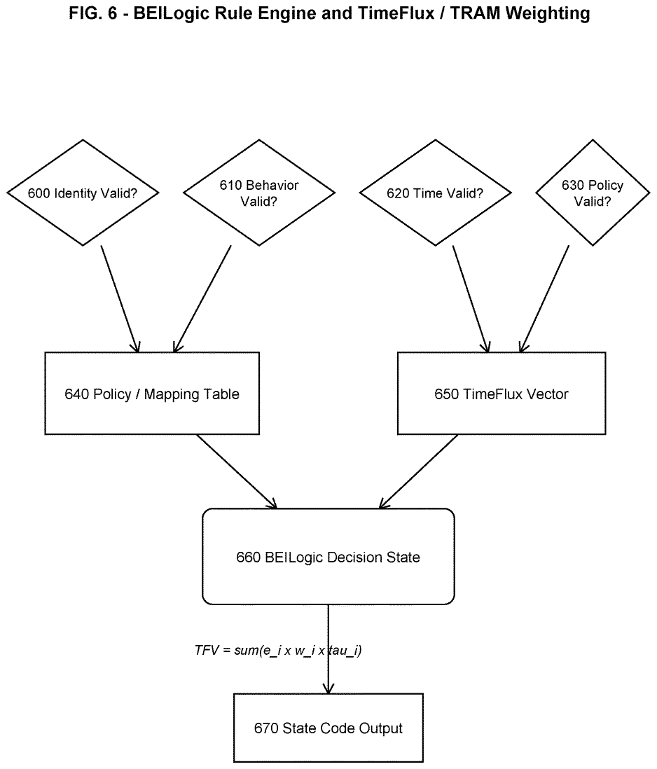

FIG. 7 illustrates signed BEI asset-state output record.

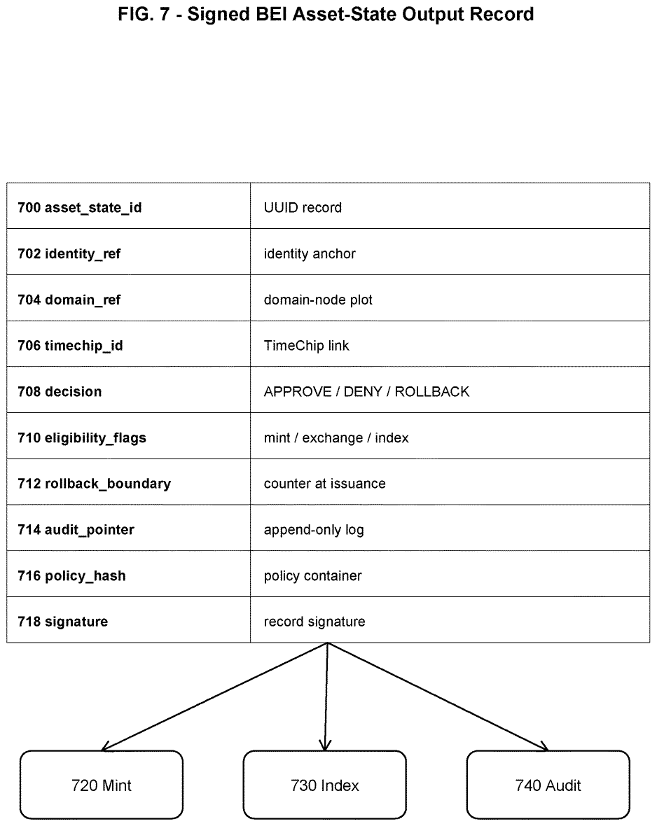

FIG. 8 illustrates domain-node/ReadName/asset plot infrastructure.

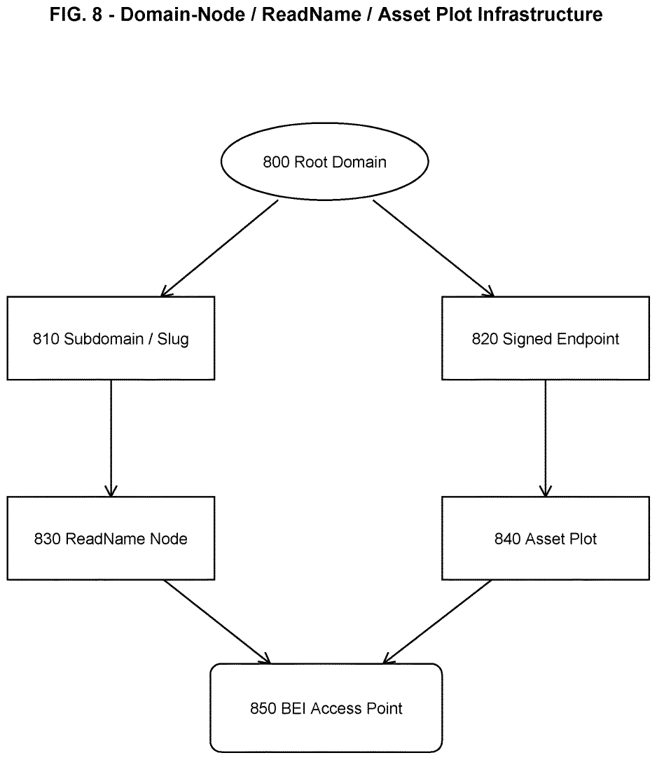

FIG. 9 illustrates BEI Access Point and signed endpoint routing.

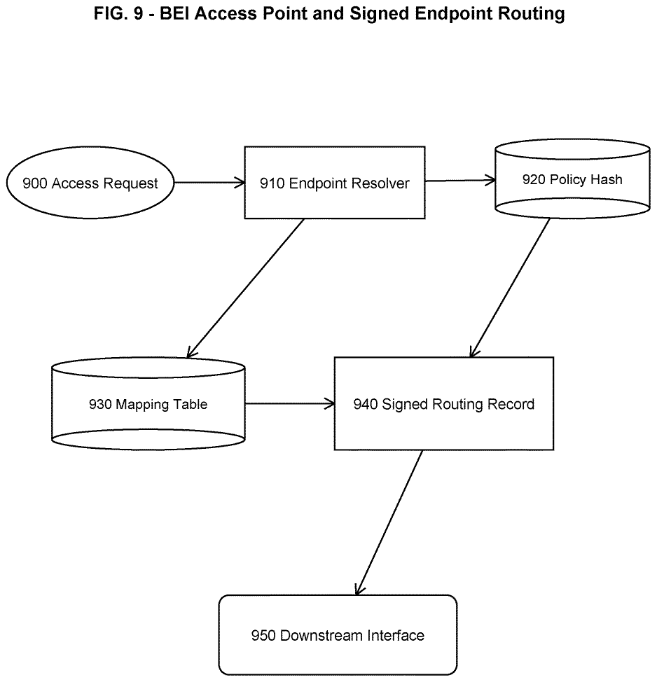

FIG. 10 illustrates BEI Node Namespace Provisioning State Machine.

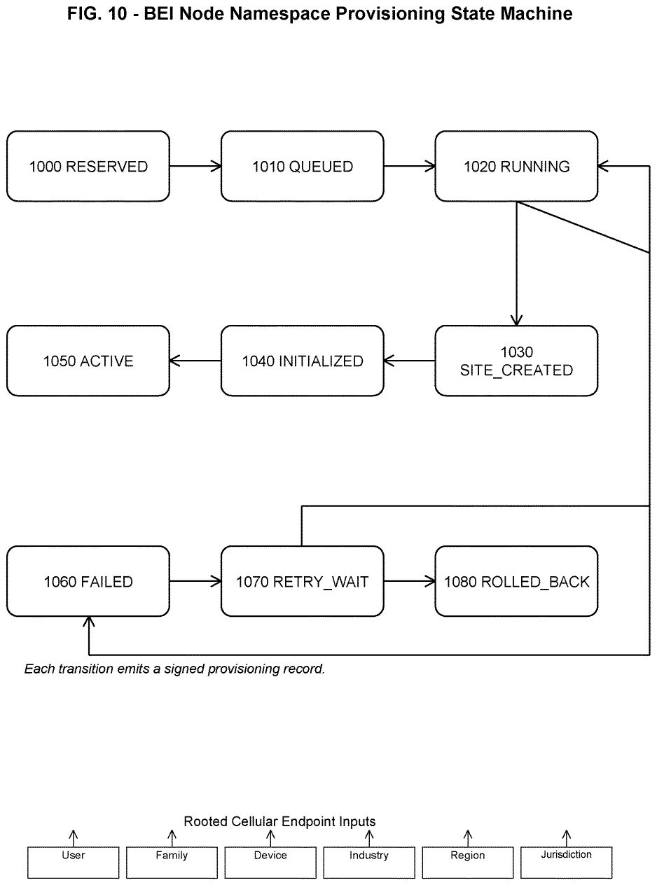

FIG. 11 illustrates Heaven-Earth-Human, medical-health, and resource mapping table.

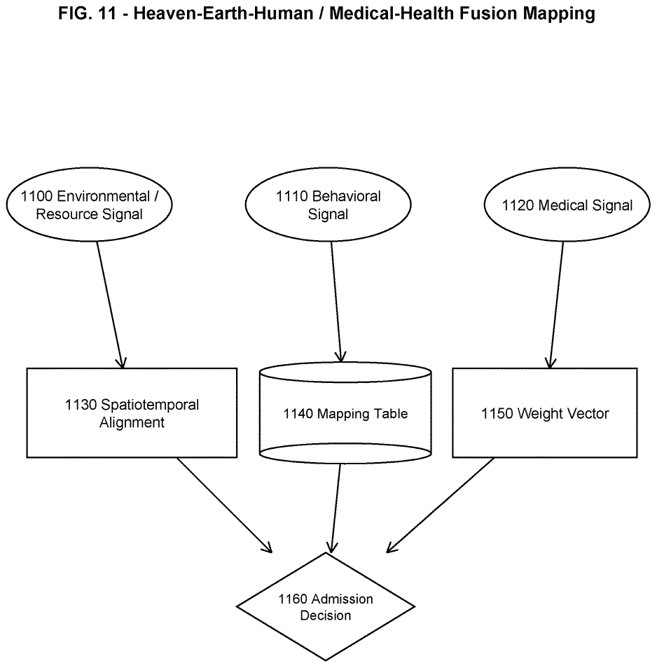

FIG. 12 illustrates BEIMint/TimeCurrency/token issuance interface.

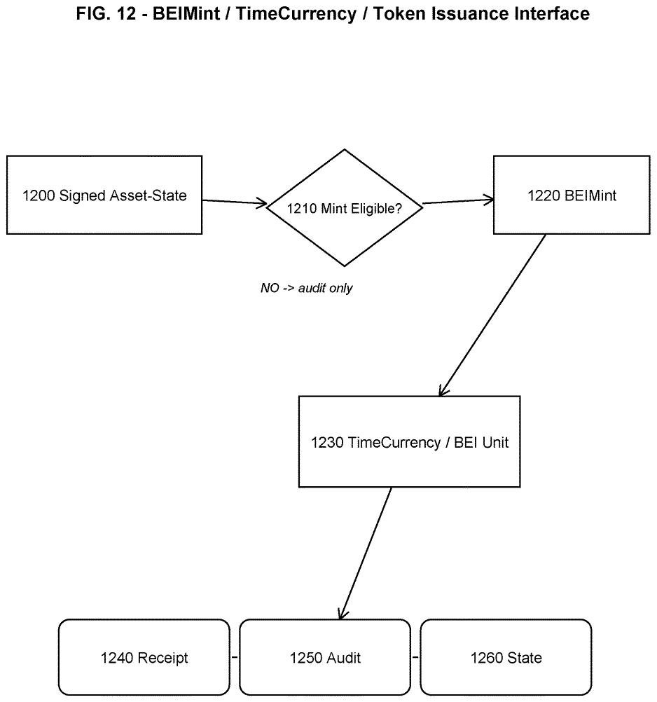

FIG. 13 illustrates BEIIndex/BIGindex valuation and data publication interface.

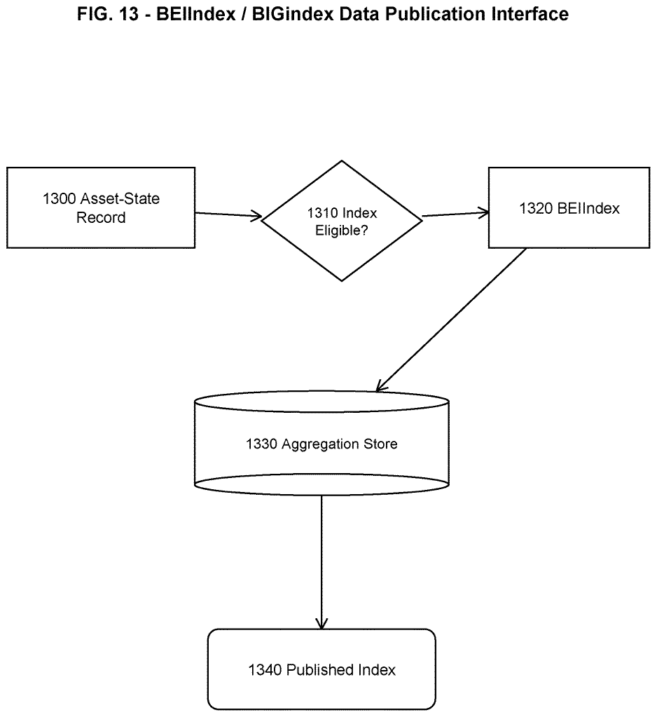

FIG. 14 illustrates BEIGX/ATMS exchange, clearing, and licensing interface.

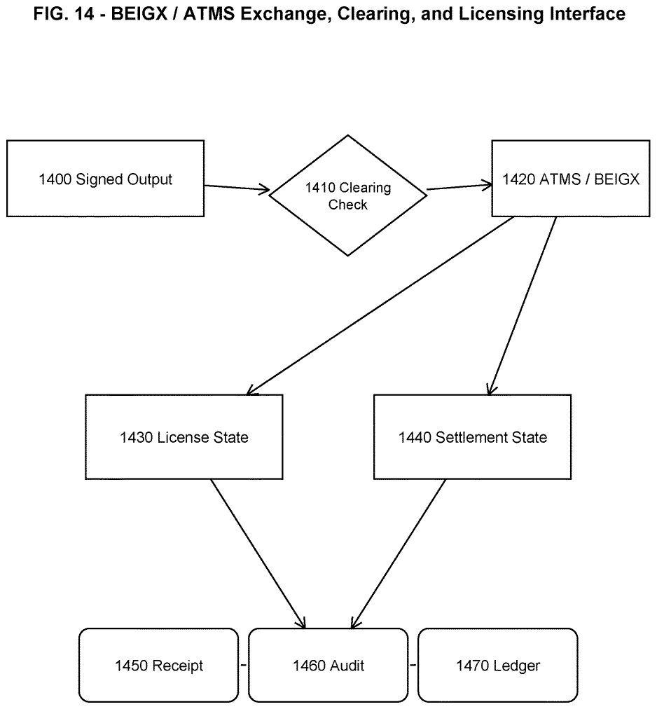

FIG. 15 illustrates principal BEILogic states including capture, verify, admit, approve, output, hold, freeze, rollback, and remediate, while FIG. 17 illustrates rollback-related correction states including clawback, reverse-clear, re-mint, and re-index processing.

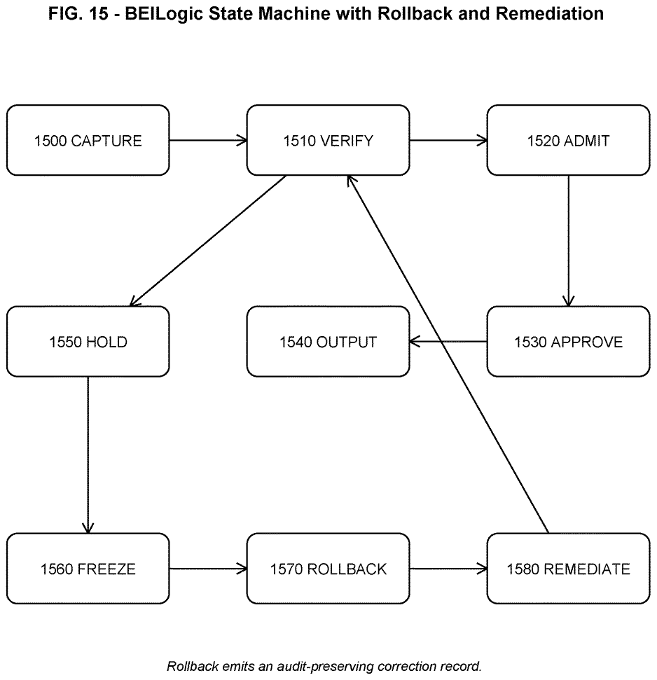

FIG. 16 illustrates end-to-end closed loop from identity to behavior to TimeChip to signed asset-state to mint, index, exchange, audit, and rollback.

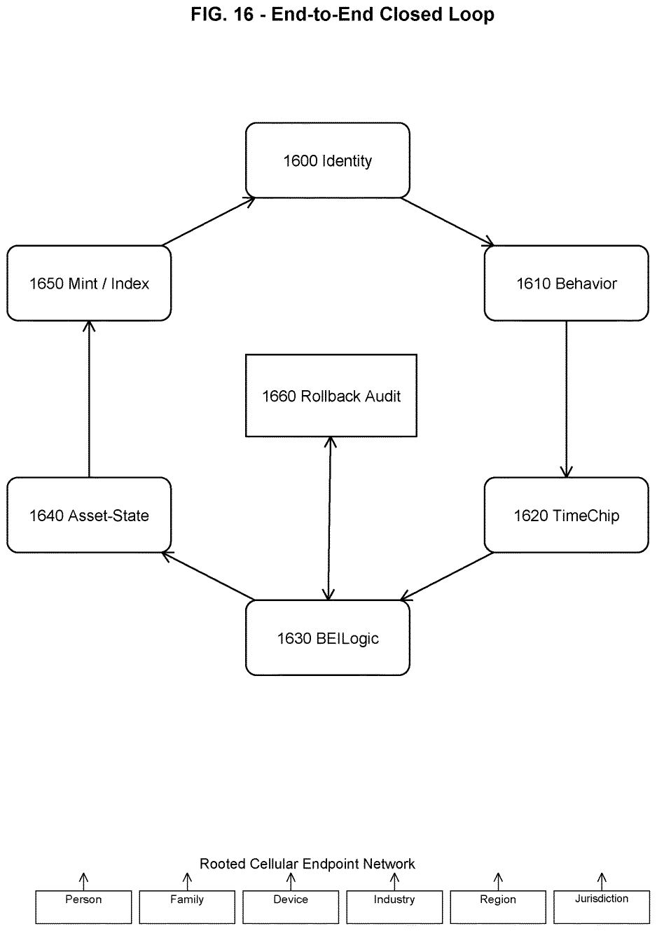

FIG. 17 illustrates TimeChip payload, signed asset-state record, BEILogic state machine, and rollback boundary processing.

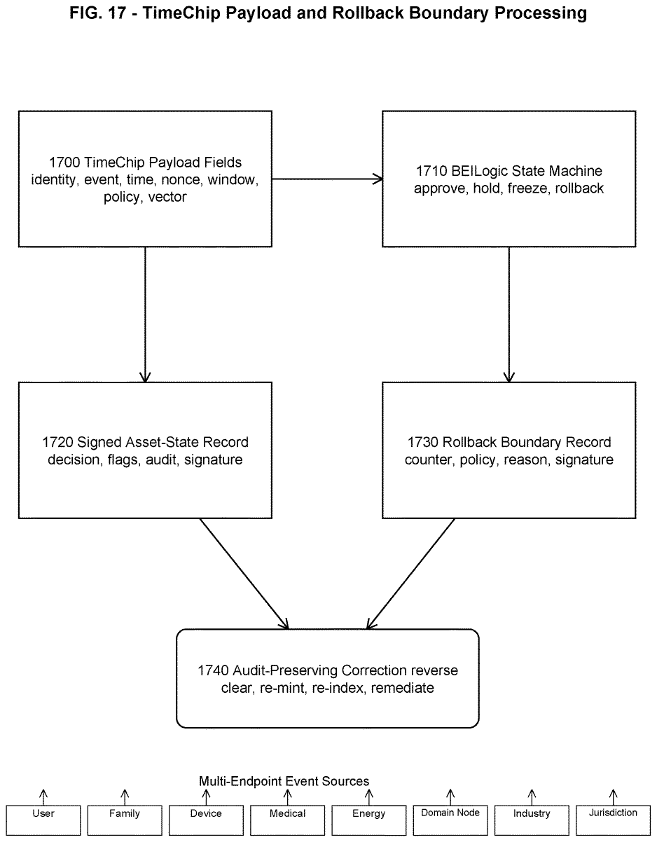

### DETAILED DESCRIPTION

### Definitions

BEILogic means a hardware-executed or hardware-backed state machine configured to evaluate identity validity, behavior validity, time validity, policy validity, replay status, mapping validity, and rollback-boundary state, and to output a deterministic asset-state decision.

TimeFlux weighting vector means a policy-defined array of weights applied to behavioral event parameters, computed as TFV=sum(e_i x w_i x tau_i), where e_i is an event category weight, w_i is a behavioral class weight, and tau_i is a policy-defined time-decay factor.

PUFShield means a hardware security layer comprising a physically unclonable function root-of-trust circuit, programmable noise injection, side-channel masking, attestation reporting, and quarantine or rollback logic.

Rollback boundary means a tamper-evident record or register value comprising at least an asset-state identifier, monotonic counter value, policy hash, audit pointer, and cryptographic signature, to which the system may revert after a verified triggering condition.

TimeChip means a machine-readable time-value fragment record comprising an event digest, identity-anchor reference, trusted-time reference, nonce, validity window, TimeFlux weighting vector, rollback boundary pointer, audit pointer, and cryptographic signature.

Domain-node asset plot means a domain name, subdomain, namespace identifier, ReadName node, wallet endpoint, device node, account node, medical terminal, resource node, supply-chain node, or provisioning node bound to a signed endpoint record and accessible through a BEI Access Point.

Signed BEI asset-state record means a machine-readable signed record indicating at least an asset-state identifier, identity reference, domain reference, TimeChip identifier, BEILogic decision code, eligibility flags, rollback boundary, audit pointer, policy hash, and cryptographic signature.

BEI Access Point means a chip-authenticated routing, provisioning, or authorization endpoint configured to validate signed endpoint records and to route signed asset-state records to downstream systems without requiring the downstream systems to be co-operators of the trusted execution infrastructure.

Green Flux means a policy-defined resource or energy contribution signal, including energy-credit, thermoelectric recovery, power-state, environmental, or sensor-attested contribution data applied to a TimeFlux weighting vector or asset-state decision.

Medical time tunnel means a bounded time window associated with clinical events, treatment episodes, medication courses, disease episodes, emergency windows, or clinical-trial periods, within which medical-health records are admitted, quarantined, downgraded, or rejected by BEILogic.

### System Architecture and Ordered Combination

The ordered combination includes an identity anchor as component 1 in the trusted path. The component is not used as an isolated business label; it participates in a machine-enforced sequence in which a prior verified state must exist before the next state can be written. In one example, the identity anchor is validated within the trusted execution module before a signed output is emitted, and any failed validation creates an audit entry rather than an arbitrary deletion.

The ordered combination includes a behavioral event envelope as component 2 in the trusted path. The component is not used as an isolated business label; it participates in a machine-enforced sequence in which a prior verified state must exist before the next state can be written. In one example, the behavioral event envelope is validated within the trusted execution module before a signed output is emitted, and any failed validation creates an audit entry rather than an arbitrary deletion.

The ordered combination includes a trusted time anchor as component 3 in the trusted path. The component is not used as an isolated business label; it participates in a machine-enforced sequence in which a prior verified state must exist before the next state can be written. In one example, the trusted time anchor is validated within the trusted execution module before a signed output is emitted, and any failed validation creates an audit entry rather than an arbitrary deletion.

The ordered combination includes a monotonic counter as component 4 in the trusted path. The component is not used as an isolated business label; it participates in a machine-enforced sequence in which a prior verified state must exist before the next state can be written. In one example, the monotonic counter is validated within the trusted execution module before a signed output is emitted, and any failed validation creates an audit entry rather than an arbitrary deletion.

The ordered combination includes a nonce cache as component 5 in the trusted path. The component is not used as an isolated business label; it participates in a machine-enforced sequence in which a prior verified state must exist before the next state can be written. In one example, the nonce cache is validated within the trusted execution module before a signed output is emitted, and any failed validation creates an audit entry rather than an arbitrary deletion.

The ordered combination includes a policy container as component 6 in the trusted path. The component is not used as an isolated business label; it participates in a machine-enforced sequence in which a prior verified state must exist before the next state can be written. In one example, the policy container is validated within the trusted execution module before a signed output is emitted, and any failed validation creates an audit entry rather than an arbitrary deletion.

The ordered combination includes a TimeChip record as component 7 in the trusted path. The component is not used as an isolated business label; it participates in a machine-enforced sequence in which a prior verified state must exist before the next state can be written. In one example, the TimeChip record is validated within the trusted execution module before a signed output is emitted, and any failed validation creates an audit entry rather than an arbitrary deletion.

The ordered combination includes a BEILogic state machine as component 8 in the trusted path. The component is not used as an isolated business label; it participates in a machine-enforced sequence in which a prior verified state must exist before the next state can be written. In one example, the BEILogic state machine is validated within the trusted execution module before a signed output is emitted, and any failed validation creates an audit entry rather than an arbitrary deletion.

The ordered combination includes a PUFShield attestation report as component 9 in the trusted path. The component is not used as an isolated business label; it participates in a machine-enforced sequence in which a prior verified state must exist before the next state can be written. In one example, the PUFShield attestation report is validated within the trusted execution module before a signed output is emitted, and any failed validation creates an audit entry rather than an arbitrary deletion.

The ordered combination includes a signed asset-state record as component 10 in the trusted path. The component is not used as an isolated business label; it participates in a machine-enforced sequence in which a prior verified state must exist before the next state can be written. In one example, the signed asset-state record is validated within the trusted execution module before a signed output is emitted, and any failed validation creates an audit entry rather than an arbitrary deletion.

The ordered combination includes a rollback boundary as component 11 in the trusted path. The component is not used as an isolated business label; it participates in a machine-enforced sequence in which a prior verified state must exist before the next state can be written. In one example, the rollback boundary is validated within the trusted execution module before a signed output is emitted, and any failed validation creates an audit entry rather than an arbitrary deletion.

The ordered combination includes an audit pointer as component 12 in the trusted path. The component is not used as an isolated business label; it participates in a machine-enforced sequence in which a prior verified state must exist before the next state can be written. In one example, the audit pointer is validated within the trusted execution module before a signed output is emitted, and any failed validation creates an audit entry rather than an arbitrary deletion.

The ordered combination includes a downstream output interface as component 13 in the trusted path. The component is not used as an isolated business label; it participates in a machine-enforced sequence in which a prior verified state must exist before the next state can be written. In one example, the downstream output interface is validated within the trusted execution module before a signed output is emitted, and any failed validation creates an audit entry rather than an arbitrary deletion.

### TimeChip Payload Data Structure

A TimeChip record may include the following field schema. The schema is one example; equivalent field lengths or encodings may be used where the represented structure includes functionally equivalent fields for event digest, identity anchor, trusted time reference, nonce, validity window, policy hash, TimeFlux vector, rollback boundary pointer, audit pointer, and signature.

TimeChip field identity_ref has an example size of 32 bytes and represents SHA-256 of cryptographic identity anchor. The field is serialized before signature generation and is included in an audit-preserving data frame used by BEILogic for deterministic decision processing.

TimeChip field event_digest has an example size of 32 bytes and represents SHA-256 of behavioral event envelope. The field is serialized before signature generation and is included in an audit-preserving data frame used by BEILogic for deterministic decision processing.

TimeChip field trusted_time_ref has an example size of 8 bytes and represents Unix epoch and source identifier or trusted clock counter. The field is serialized before signature generation and is included in an audit-preserving data frame used by BEILogic for deterministic decision processing.

TimeChip field nonce has an example size of 16 bytes and represents CSPRNG-generated, single-use value verified against nonce cache. The field is serialized before signature generation and is included in an audit-preserving data frame used by BEILogic for deterministic decision processing.

TimeChip field validity_window has an example size of 8 bytes and represents start epoch and duration seconds or equivalent bounded window. The field is serialized before signature generation and is included in an audit-preserving data frame used by BEILogic for deterministic decision processing.

TimeChip field policy_hash has an example size of 32 bytes and represents SHA-256 of active policy container. The field is serialized before signature generation and is included in an audit-preserving data frame used by BEILogic for deterministic decision processing.

TimeChip field timeflux_vector has an example size of variable and represents serialized policy-defined weighting array. The field is serialized before signature generation and is included in an audit-preserving data frame used by BEILogic for deterministic decision processing.

TimeChip field rollback_boundary_ptr has an example size of 32 bytes and represents pointer to last verified rollback boundary record. The field is serialized before signature generation and is included in an audit-preserving data frame used by BEILogic for deterministic decision processing.

TimeChip field audit_pointer has an example size of 32 bytes and represents pointer to append-only audit log entry. The field is serialized before signature generation and is included in an audit-preserving data frame used by BEILogic for deterministic decision processing.

TimeChip field signature has an example size of 64 bytes and represents ECDSA P-256, Ed25519, or equivalent signature over preceding fields. The field is serialized before signature generation and is included in an audit-preserving data frame used by BEILogic for deterministic decision processing.

TimeChip processing step 1 may receive the event envelope and extract an identity reference. The step is performed within or verified by a trusted execution module so that an untrusted host operating system cannot modify the result without invalidating the signature or counter continuity.

TimeChip processing step 2 may compute event_digest from event data. The step is performed within or verified by a trusted execution module so that an untrusted host operating system cannot modify the result without invalidating the signature or counter continuity.

TimeChip processing step 3 may obtain trusted_time_ref from a secure clock, monotonic counter, medical time tunnel, or network time source. The step is performed within or verified by a trusted execution module so that an untrusted host operating system cannot modify the result without invalidating the signature or counter continuity.

TimeChip processing step 4 may generate nonce from a cryptographically secure random source. The step is performed within or verified by a trusted execution module so that an untrusted host operating system cannot modify the result without invalidating the signature or counter continuity.

TimeChip processing step 5 may verify the nonce against a hardware-resident nonce cache. The step is performed within or verified by a trusted execution module so that an untrusted host operating system cannot modify the result without invalidating the signature or counter continuity.

TimeChip processing step 6 may compute timeflux_vector from the active policy container. The step is performed within or verified by a trusted execution module so that an untrusted host operating system cannot modify the result without invalidating the signature or counter continuity.

TimeChip processing step 7 may set validity_window based on policy and event class. The step is performed within or verified by a trusted execution module so that an untrusted host operating system cannot modify the result without invalidating the signature or counter continuity.

TimeChip processing step 8 may retrieve rollback_boundary_ptr from secure memory. The step is performed within or verified by a trusted execution module so that an untrusted host operating system cannot modify the result without invalidating the signature or counter continuity.

TimeChip processing step 9 may write audit_pointer to append-only log. The step is performed within or verified by a trusted execution module so that an untrusted host operating system cannot modify the result without invalidating the signature or counter continuity.

TimeChip processing step 10 may compute signature using a device-unique key or HSM-backed key. The step is performed within or verified by a trusted execution module so that an untrusted host operating system cannot modify the result without invalidating the signature or counter continuity.

### Signed BEI Asset-State Record Schema

The signed BEI asset-state record may include asset_state_id, which represents globally unique identifier for the asset-state record. The record is formatted by the signature output serializer after BEILogic determines an output state and before downstream systems are permitted to act on the record.

The signed BEI asset-state record may include identity_ref, which represents cryptographic identity reference linking to the identity anchor. The record is formatted by the signature output serializer after BEILogic determines an output state and before downstream systems are permitted to act on the record.

The signed BEI asset-state record may include domain_ref, which represents hash or identifier of the associated domain-node asset plot. The record is formatted by the signature output serializer after BEILogic determines an output state and before downstream systems are permitted to act on the record.

The signed BEI asset-state record may include timechip_id, which represents identifier of the TimeChip record used to create the state. The record is formatted by the signature output serializer after BEILogic determines an output state and before downstream systems are permitted to act on the record.

The signed BEI asset-state record may include beilogic_decision, which represents one-byte or equivalent code such as approve, deny, hold, freeze, revoke, remediate, rollback, or clawback. The record is formatted by the signature output serializer after BEILogic determines an output state and before downstream systems are permitted to act on the record.

The signed BEI asset-state record may include eligibility_flags, which represents bitfield identifying mint, exchange, index, license, medical, namespace, rollback, or compliance eligibility. The record is formatted by the signature output serializer after BEILogic determines an output state and before downstream systems are permitted to act on the record.

The signed BEI asset-state record may include rollback_boundary, which represents monotonic counter value or pointer associated with the issuance state. The record is formatted by the signature output serializer after BEILogic determines an output state and before downstream systems are permitted to act on the record.

The signed BEI asset-state record may include audit_pointer, which represents append-only audit log pointer. The record is formatted by the signature output serializer after BEILogic determines an output state and before downstream systems are permitted to act on the record.

The signed BEI asset-state record may include policy_hash, which represents hash of the active policy container. The record is formatted by the signature output serializer after BEILogic determines an output state and before downstream systems are permitted to act on the record.

The signed BEI asset-state record may include signature, which represents signature over all preceding fields. The record is formatted by the signature output serializer after BEILogic determines an output state and before downstream systems are permitted to act on the record.

The asset-state record may be represented as a record, token, credential, authorization payload, identity certificate, signed envelope, signed receipt, medical admission certificate, namespace provisioning record, energy contribution certificate, or rollback receipt, provided that the represented structure contains fields functionally equivalent to the fields described herein.

### BEILogic State Machine

BEILogic state APPROVE may be selected when all required validity inputs true and no replay detected. The resulting action may set eligibility flags as permitted by policy and emit signed asset-state record. The state is recorded as a state-transition control code in the signed asset-state record or associated audit record.

BEILogic state HOLD may be selected when policy state incomplete or review needed. The resulting action may write audit entry and block mint, exchange, and index flags. The state is recorded as a state-transition control code in the signed asset-state record or associated audit record.

BEILogic state DENY may be selected when identity, behavior, time, or policy validity failed. The resulting action may emit deny record and preserve reason code. The state is recorded as a state-transition control code in the signed asset-state record or associated audit record.

BEILogic state FREEZE may be selected when freeze signal, dispute, anomaly, or compliance hold exists. The resulting action may clear downstream flags and mark record non-transferable. The state is recorded as a state-transition control code in the signed asset-state record or associated audit record.

BEILogic state REVOKE may be selected when replay detected or authorization withdrawn. The resulting action may invalidate nonce or credential and write revocation audit entry. The state is recorded as a state-transition control code in the signed asset-state record or associated audit record.

BEILogic state REMEDIATE may be selected when operator-authorized correction path exists. The resulting action may re-run checks after remediation and preserve correction record. The state is recorded as a state-transition control code in the signed asset-state record or associated audit record.

BEILogic state ROLLBACK may be selected when verified rollback trigger and boundary record exists. The resulting action may revert to boundary state and emit rollback audit record. The state is recorded as a state-transition control code in the signed asset-state record or associated audit record.

BEILogic state CLAWBACK may be selected when downstream clearing reversal required. The resulting action may clear affected flags and emit clawback record. The state is recorded as a state-transition control code in the signed asset-state record or associated audit record.

BEILogic state REVERSE_CLEAR may be selected when clearing transaction must be reversed. The resulting action may send reversal record to clearing interface. The state is recorded as a state-transition control code in the signed asset-state record or associated audit record.

BEILogic state RE-MINT may be selected when corrected record allows reissuance. The resulting action may emit new minting eligibility decision. The state is recorded as a state-transition control code in the signed asset-state record or associated audit record.

BEILogic state RE-INDEX may be selected when corrected record allows re-indexing. The resulting action may emit index update decision. The state is recorded as a state-transition control code in the signed asset-state record or associated audit record.

### Rollback Boundary Record and Bounded Rollback Protocol

A rollback boundary record may comprise an asset-state identifier, monotonic counter value, policy hash, rollback reason code, affected eligibility flags, audit pointer, operator reference when applicable, and cryptographic signature. The record is stored in a rollback boundary register, secure memory region, or tamper-evident log that is accessible to the trusted execution module.

A triggering condition for rollback may include replay attack, anomaly score exceeding a threshold, operator-initiated remediation, clawback signal from a downstream clearing system, compliance violation, medical admission correction, duplicate provisioning event, expired credential, withdrawn consent, or detected endpoint spoofing.

Verification of a rollback boundary may include validating the cryptographic signature, comparing the stored monotonic counter value against a current monotonic counter value, checking whether the policy hash matches an active or accepted policy container, confirming that the rollback is within an authorized correction window, and confirming that downstream reversal operations are supported by policy.

When the rollback boundary is verified, BEILogic may clear eligibility flags set after the boundary state, write a rollback audit record to an append-only log, send a reverse-clear message to a clearing system, cause re-mint or re-index if permitted, and preserve the original record rather than deleting it.

The bounded rollback protocol distinguishes the disclosed system from a merely immutable record system. The system is neither arbitrary deletion nor uncontrolled mutation. Instead, it is an audit-preserving correction mechanism having a bounded state, verified counter, policy hash, and signed record trail.

### PUFShield/TEE/HSM Execution Boundary

In a hardware-assisted embodiment, a PUF root-of-trust circuit generates a device-unique key from manufacturing variations. The device-unique key may be re-derived on boot rather than stored in non-volatile memory. A signing key or attestation key may be derived directly or indirectly from the device-unique key.

In a secure enclave embodiment, BEILogic executes in an isolated domain. The normal-world operating system provides event envelopes but cannot modify secure memory, nonce cache, policy hash register, state transition table, or rollback boundary register without detection by signature verification or counter continuity checks.

In an HSM-backed server embodiment, the HSM receives a mailbox message containing an event digest, identity reference, trusted time reference, and policy reference. The HSM validates nonce and policy state, signs the asset-state record, and returns only the signed output and audit pointer to the host server.

In a cloud enclave embodiment, the trusted execution environment may be implemented by a confidential computing enclave, secure virtual machine, or HSM-backed key service. The same TimeChip, BEILogic, rollback boundary, and signed asset-state record flow is preserved even if the enclave is remotely hosted.

In a software-defined BEPU embodiment, a software-defined chip module executes within a hardware-backed secure execution service and uses protected memory, measured boot, key attestation, monotonic counter service, nonce cache, and signed output serialization to perform the same functions described herein.

Noise injection, side-channel masking, protocol-agility control, honeypot endpoint simulation, anomaly detection, quarantine, and checkpoint rollback may be implemented in hardware, firmware, software within a TEE, or combinations thereof, depending on the deployment environment.

### Anti-Replay and Idempotency Protocol

A requestor may generate a 128-bit nonce using a cryptographically secure random number generator. The nonce is included in the behavioral event envelope and signed by the requestor or associated device before transmission to the BEIChip trusted execution boundary.

The trusted execution module may check the nonce against a nonce cache using least-recently-used eviction and a time-to-live equal to the validity window. If the nonce is found, BEILogic selects a replay detected state and writes a revocation or rejection audit entry.

If the nonce is not found, the nonce may be inserted into the nonce cache, and the event may proceed to identity, behavior, time, policy, and mapping checks. The nonce may be purged when the validity window expires or upon session termination.

An idempotency key may be computed as HMAC-SHA256 over identity reference, event digest, and a timestamp floor or reservation window. Duplicate submissions of the same behavioral event within the same validity window return the previously signed asset-state record without duplicate processing.

A duplicate-risk score may be computed from event type frequency, identity event rate, time density, endpoint repetition, medical record similarity, or provisioning state similarity. BEILogic may quarantine or reject events exceeding a policy threshold.

### Domain-Node and BEI Node Namespace Provisioning

The BEI Node namespace provisioning state machine may process a node from reservation to active deployment while emitting a signed provisioning record at each state transition. The provisioning state machine enables a domain-node asset plot to be treated as a signed endpoint rather than merely as a conventional web address.

Provisioning state reserved may be represented by a state code in a signed provisioning record. In the reserved state, the BEI Access Point may store root_domain_id, node_slug, reservation_id, order_id, user_id, idempotency_key, endpoint_hash, policy_hash, timestamp, and signature for audit-preserving operation.

Provisioning state queued may be represented by a state code in a signed provisioning record. In the queued state, the BEI Access Point may store root_domain_id, node_slug, reservation_id, order_id, user_id, idempotency_key, endpoint_hash, policy_hash, timestamp, and signature for audit-preserving operation.

Provisioning state running may be represented by a state code in a signed provisioning record. In the running state, the BEI Access Point may store root_domain_id, node_slug, reservation_id, order_id, user_id, idempotency_key, endpoint_hash, policy_hash, timestamp, and signature for audit-preserving operation.

Provisioning state site_created may be represented by a state code in a signed provisioning record. In the site_created state, the BEI Access Point may store root_domain_id, node_slug, reservation_id, order_id, user_id, idempotency_key, endpoint_hash, policy_hash, timestamp, and signature for audit-preserving operation.

Provisioning state initialized may be represented by a state code in a signed provisioning record. In the initialized state, the BEI Access Point may store root_domain_id, node_slug, reservation_id, order_id, user_id, idempotency_key, endpoint_hash, policy_hash, timestamp, and signature for audit-preserving operation.

Provisioning state active may be represented by a state code in a signed provisioning record. In the active state, the BEI Access Point may store root_domain_id, node_slug, reservation_id, order_id, user_id, idempotency_key, endpoint_hash, policy_hash, timestamp, and signature for audit-preserving operation.

Provisioning state failed may be represented by a state code in a signed provisioning record. In the failed state, the BEI Access Point may store root_domain_id, node_slug, reservation_id, order_id, user_id, idempotency_key, endpoint_hash, policy_hash, timestamp, and signature for audit-preserving operation.

Provisioning state retry_wait may be represented by a state code in a signed provisioning record. In the retry_wait state, the BEI Access Point may store root_domain_id, node_slug, reservation_id, order_id, user_id, idempotency_key, endpoint_hash, policy_hash, timestamp, and signature for audit-preserving operation.

Provisioning state cancelled may be represented by a state code in a signed provisioning record. In the cancelled state, the BEI Access Point may store root_domain_id, node_slug, reservation_id, order_id, user_id, idempotency_key, endpoint_hash, policy_hash, timestamp, and signature for audit-preserving operation.

Provisioning state rolled_back may be represented by a state code in a signed provisioning record. In the rolled_back state, the BEI Access Point may store root_domain_id, node_slug, reservation_id, order_id, user_id, idempotency_key, endpoint_hash, policy_hash, timestamp, and signature for audit-preserving operation.

The namespace provisioning record may include root_domain_id, node_slug, reservation_id, order_id, user_id, state_code, idempotency_key, endpoint_hash, policy_container_hash, timestamp, and signature. Duplicate provisioning requests for the same root domain and slug may return an existing signed record rather than creating duplicate nodes.

The rolled_back provisioning state may revert to the last active or initialized state recorded in an append-only provisioning log. The rollback record may include a triggering condition, operator reference, previous state, target state, monotonic counter value, and cryptographic signature.

### Configurable Need-Industry-Resource-Currency-Jurisdiction Mapping Architecture

The configurable mapping table maps one or more need categories, industry categories, resource classes, currency classes, jurisdictional rules, identity classes, permission states, compliance states, rollback states, and downstream eligibility states to BEILogic decision rules.

The mapping table may include household needs, medical needs, emergency needs, education needs, work-service needs, financial needs, energy needs, food and agriculture needs, housing needs, mobility needs, supply-chain needs, public-health needs, environmental-resource needs, governance needs, cultural-service needs, digital-identity needs, digital-property needs, and other configurable human-need or industry categories.

The mapping table may be expanded, reduced, substituted, localized, or updated by a signed policy container without changing the underlying BEIChip/BEILogic execution architecture. In a non-limiting configuration, the table may include hundreds of need entries and hundreds of industry entries, including a configuration having 999 need entries and 365 industry entries.

An industry-specific event adapter may translate a domain-specific event into a behavioral event envelope. Such domain-specific events may include medical events, educational events, work-service events, household-service events, agricultural events, energy events, financial events, supply-chain events, emergency-response events, environmental-resource events, public-service events, domain-node provisioning events, and device telemetry events.

A policy adapter may translate industry-specific rules into a signed policy container. The signed policy container may contain a policy hash, version identifier, source authorization rule, role rule, jurisdiction rule, privacy rule, remediation directive, bounded outcome table, rollback limit, and expiration or update rule.

A resource adapter may translate a resource demand, resource availability state, environmental state, currency class, jurisdictional rule, or compliance state into a mapping-table entry. An output adapter may translate a signed BEI asset-state record into a downstream service instruction without changing the trusted-execution path.

The same trusted execution path may generate a TimeChip, evaluate BEILogic, produce a signed BEI asset-state record, and route the record to an industry-specific downstream system. Thus the architecture supports multiple industry routes through a common identity-time-policy-state verification spine.

The fusion module may compute a policy-defined weighting vector from environmental signals, behavioral signals, resource signals, clinical-evidence signals, device signals, energy signals, education signals, work signals, household signals, emergency-response signals, time-window signals, industry classifications, identity classifications, and resource-availability states.

The mapping table may be used by a medical-health adapter, energy adapter, education adapter, financial adapter, agriculture adapter, supply-chain adapter, domain-node adapter, emergency-response adapter, public-service adapter, or governance adapter.

A downstream system may receive only a signed BEI asset-state record and need not operate the full BEIChip/BEILogic stack. The downstream system may verify the signature, policy hash, audit pointer, rollback boundary, and eligibility flags to determine whether the event is acceptable for the downstream use case.

The configurable mapping table permits static states, including identity, resource, domain, policy, entitlement, jurisdiction, and permission state, to be combined with dynamic events, including behavior, transaction, service, signal, emergency, minting, clearing, and provisioning events, through BEILogic state transition logic.

In this manner, the architecture is not limited to a single industry route. It provides a domain-agnostic trusted-execution path for converting a domain-specific event and policy container into a signed asset-state record.

### Medical-Health Vertical Implementation

Medical admission gate check SOURCE_AUTHORITY may verify medical source license or provider registry status. The result may be accepted, rejected, downgraded, quarantined, physician_review, emergency_only, or research_only, and the result may be recorded as a BEILogic decision code in a signed asset-state record.

Medical admission gate check CONSENT_STATE may verify that the subject consent record is active and covers requested scope. The result may be accepted, rejected, downgraded, quarantined, physician_review, emergency_only, or research_only, and the result may be recorded as a BEILogic decision code in a signed asset-state record.

Medical admission gate check DATA_QUALITY_SCORE may compute completeness, timeliness, and source reliability score. The result may be accepted, rejected, downgraded, quarantined, physician_review, emergency_only, or research_only, and the result may be recorded as a BEILogic decision code in a signed asset-state record.

Medical admission gate check TEMPORAL_CONSISTENCY may verify event time is inside medical time tunnel. The result may be accepted, rejected, downgraded, quarantined, physician_review, emergency_only, or research_only, and the result may be recorded as a BEILogic decision code in a signed asset-state record.

Medical admission gate check CLINICAL_RELEVANCE may verify event type and condition code relationship. The result may be accepted, rejected, downgraded, quarantined, physician_review, emergency_only, or research_only, and the result may be recorded as a BEILogic decision code in a signed asset-state record.

Medical admission gate check DUPLICATE_RISK may check idempotency key and similarity of prior events. The result may be accepted, rejected, downgraded, quarantined, physician_review, emergency_only, or research_only, and the result may be recorded as a BEILogic decision code in a signed asset-state record.

Medical admission gate check ANOMALY_FLAG may quarantine or route to physician review when anomaly score exceeds threshold. The result may be accepted, rejected, downgraded, quarantined, physician_review, emergency_only, or research_only, and the result may be recorded as a BEILogic decision code in a signed asset-state record.

A medical event may include a prescription, laboratory order, diagnostic observation, treatment episode, medication course, disease episode, emergency disclosure event, clinical-trial period, home sensor observation, wearable device signal, or provider-authenticated consultation record. The event may be admitted only when source authority, consent, time, duplicate-risk, and policy conditions satisfy the active policy container.

In an emergency-only embodiment, a limited subset of medical information may be disclosed through a BEI Access Point while preserving audit logs and bounded rollback capability. The emergency disclosure record may expire automatically according to the validity window and may be reviewed after the emergency event.

### Green Flux and Resource Contribution Implementation

A Green Flux module may receive a energy-credit signal and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a thermoelectric recovery signal and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a power-state signal and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a environmental signal and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a sensor-attested energy contribution and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a water-use signal and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a solar generation signal and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a EV charging signal and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a resource conservation signal and apply the signal to a policy-defined weighting rule inside the TimeFlux vector computation. The signal may be signed by an IoT device, energy meter, mobile device, inverter, or edge gateway before entering the trusted execution boundary.

A Green Flux module may receive a agricultural sensor signal and apply the signal to a policy-defined weighting rule inside the TimeFlux vector computation. The signal may be signed by an IoT device, energy meter, mobile device, inverter, or edge gateway before entering the trusted execution boundary.

Green Flux does not require the system to control natural resources. Instead, it represents resource-related behavior or telemetry as signed event evidence within a trusted execution infrastructure. The resulting asset-state decision may be limited to verification, indexing, compliance, or resource-credit eligibility as permitted by policy.

Standards-Compatible Trusted-Execution and Product-Service Interface Embodiments

In various embodiments, the BEIChip apparatus may be implemented as a local hardware chip, mobile secure element, HSM-backed server, cloud enclave, software-defined BEPU, IoT gateway security module, medical device controller, domain-node router, wallet device, or edge provisioning node.

In some embodiments, BEILogic may be implemented as a trusted application in a GlobalPlatform-compatible trusted execution environment, as firmware in a secure microcontroller, as a TPM-backed or HSM-backed signing service, as a cloud confidential-computing enclave service, as a mobile secure element service, as an IoT security module, as a PUF-backed secure element, or as a software-defined BEPU module.

In some embodiments, a FIDO2-compatible authenticator, WebAuthn credential, passkey, device certificate, X.509 certificate, verifiable credential, decentralized identifier, or equivalent identity-authentication input supplies an identity-authentication factor. BEILogic then separately evaluates behavioral-event validity, trusted-time validity, policy validity, resource mapping, permission state, rollback-boundary state, and signed asset-state output.

The disclosed system is not limited to replacement of an existing secure chip. An existing secure chip, secure element, TEE, HSM, TPM, secure MCU, cloud enclave, medical controller, IoT controller, domain registrar system, identity platform, clearing platform, or exchange platform may add BEI-compatible event submission, TimeChip generation, signed asset-state output, and rollback-boundary processing as an additional trusted-execution service.

A secure mailbox interface may receive behavioral event envelopes, signed policy containers, identity references, nonce values, and optional domain-node references, and may return TimeChip records, BEILogic decision codes, signed BEI asset-state records, rollback-boundary responses, PUFShield attestation reports, provisioning records, medical-admission records, or audit-export responses.

Example secure mailbox commands may include BEI_INIT, BEI_LOAD_POLICY, BEI_SUBMIT_EVENT, BEI_MAKE_TIMECHIP, BEI_EVALUATE_STATE, BEI_SIGN_ASSET_STATE, BEI_SET_ROLLBACK_BOUNDARY, BEI_EXPORT_AUDIT, BEI_PROVISION_NODE, and BEI_MED_ADMISSION. Equivalent command names, function calls, remote procedure calls, message frames, or firmware entry points may be used.

A signed BEI asset-state interface may be used by minting, indexing, exchange, clearing, medical-admission, namespace-provisioning, compliance, licensing, rollback, or audit systems. A domain-node provisioning interface may expose root-domain selection, node-slug validation, reservation, queued execution, active-state activation, rollback logging, and signed endpoint publication.

In some embodiments, a clearing or settlement interface may interoperate with ISO 20022-compatible messages, account-ledger connectors, wallet connectors, payment-rail connectors, token-ledger connectors, or other settlement-message formats. Such interoperability does not require the downstream system to execute BEILogic, provided that the downstream system receives and verifies the signed BEI asset-state record or a derived settlement receipt.

A BEI-compatible implementation may include a conformance test suite configured to test secure-mailbox command handling, TimeChip serialization, nonce-cache behavior, monotonic counter binding, PUFShield attestation verification, BEILogic state transitions, signed asset-state generation, rollback-boundary processing, namespace provisioning, medical admission, and audit-export formatting.

A test vector may include sample values for identity_ref, event_digest, trusted_time_ref, nonce, validity_window, policy_hash, timeflux_vector, rollback_boundary_ptr, audit_pointer, and expected signature verification result. The same test vector may be executed against a local secure element, TEE trusted application, HSM-backed service, TPM-backed service, secure microcontroller, or cloud enclave.

An SDK may expose callable functions for initialization, policy loading, event submission, TimeChip creation, BEILogic evaluation, asset-state signing, rollback-boundary setting, provisioning-state transition, medical-admission evaluation, audit export, and verification of a received signed asset-state record.

The SDK may include C, Rust, WebAssembly, Python test tooling, firmware bindings, remote procedure call bindings, or equivalent language bindings. The SDK need not implement all downstream systems, but may implement an interface layer sufficient for a chip vendor, medical platform, domain-node provider, energy IoT platform, clearing system, or exchange system to verify and transmit signed BEI records.

### Equivalent Data Representations and Interface Records

TimeChip may be represented as a payload, envelope, credential, token, fragment, data frame, signed record, secure mailbox response, or hardware-attested time-value object.

Asset-state may be represented as a record, authorization payload, identity certificate, signed envelope, settlement instruction, minting eligibility object, indexing eligibility object, licensing state, or clearing state.

Rollback boundary may be represented as a rollback field, correction window, remediation boundary, reverse-clearing range, re-indexing boundary, re-minting limit, audit-preserving correction scope, state checkpoint, counter value, or boundary pointer.

Domain-node asset plot may be represented as a domain name, subdomain, namespace identifier, endpoint record, wallet endpoint, device endpoint, account node, medical terminal, resource node, supply-chain node, or edge provisioning node.

Policy container may be represented as a signed policy bundle, signed rule file, governance object, smart-contract policy, compliance profile, jurisdictional rule package, device policy, clinical policy, or resource allocation policy. The representations in this section are non-limiting and may be substituted by equivalent data structures that preserve identity binding, time binding, policy binding, audit pointer, rollback-boundary handling, and signed asset-state output.

### End-to-End Medical Example

Medical example step 1: A licensed provider terminal receives a patient identity signal and generates a cryptographic identity anchor inside the trusted execution module.

Medical example step 2: The provider records a prescription, follow-up visit, diagnostic result, or laboratory order as a behavioral event envelope.

Medical example step 3: The terminal obtains a trusted time reference and records a current monotonic counter value associated with that time reference.

Medical example step 4: The system generates a TimeChip containing the event digest, identity reference, trusted time reference, nonce, validity window, policy hash, TimeFlux vector, rollback boundary pointer, audit pointer, and signature.

Medical example step 5: The medical admission gate evaluates source authority, consent state, data quality, temporal consistency, clinical relevance, duplicate risk, and anomaly flag.

Medical example step 6: BEILogic selects an approve, hold, quarantine, physician_review, emergency_only, research_only, deny, or rollback state.

Medical example step 7: The signature output serializer emits a signed asset-state record to a hospital BEI Access Point, medical resource clearing interface, or audit system.

Medical example step 8: If a duplicate prescription or anomaly is detected, the rollback boundary is verified, affected eligibility flags are cleared, and a rollback audit record is emitted.

### Domain-Rooted Product Endpoint Embodiments

In some embodiments, a domain-node asset plot is implemented by a root domain, subdomain, application domain, identity domain, medical domain, emergency-response domain, minting domain, index domain, exchange domain, clearing domain, record domain, resource domain, or governance domain.

Each domain-node endpoint may provide a signed endpoint record that binds a namespace identifier, identity anchor, policy-container hash, TimeChip reference, BEI asset-state record, audit pointer, rollback boundary, and routing metadata. Each endpoint may be accessed only after chip-authenticated verification of the signed endpoint record.

In one non-limiting implementation, an application endpoint may be associated with a user-facing BEI record interface such as BEI.app; a clearing endpoint may be associated with an asset-time-monetary clearing interface such as ATMS.com; an exchange endpoint may be associated with an asset-state transfer or licensing workflow such as BEIGX.com; a time-value endpoint may be associated with a TimeCurrency interface; a minting endpoint may be associated with BEIMint; and an indexing endpoint may be associated with BEIIndex or BIGindex.

In one non-limiting medical-health implementation, a medical domain endpoint such as medicalcenter.us may receive medical event envelopes, execute medical admission checks, issue signed medical asset-state records, and support physician_review, emergency_only, research_only, quarantined, and rollback states. An emergency-response domain endpoint such as 120.us may verify an emergency trigger, issue a time-limited emergency_only asset-state, preserve an audit trail, and permit later bounded correction.

In further non-limiting implementations, an identity endpoint may be associated with BEIDID, a record endpoint may be associated with BEIRecord, a namespace routing endpoint may be associated with DNSBEI or BEINets, an ecosystem coordination endpoint may be associated with BEIECO, an operating-system endpoint may be associated with BEISOS, and a governance or jurisdictional node may be associated with BEINation or BINation.

The domain labels are examples of implementation endpoints and may be substituted by other domain labels, subdomains, application identifiers, namespace identifiers, account identifiers, device identifiers, or endpoint identifiers.

The domain-rooted endpoint architecture permits the same signed BEI asset-state record to be routed to different product-service environments, including user-facing applications, identity systems, medical systems, emergency-response systems, minting systems, index systems, exchange systems, clearing systems, resource systems, and governance systems. A domain-name endpoint may be activated by the namespace provisioning state machine, bound to a signed endpoint record, associated with an identity anchor and policy container, and routed to a BEI Access Point. The endpoint may then receive a signed asset-state record or submit a domain-node provisioning event to the trusted execution module.

### Industrial Applicability, Product-Service Interfaces, and Licensing-Clearing Embodiments

The disclosed architecture has industrial applicability as a trusted-execution core for chips, secure elements, HSMs, TEEs, TPM-backed services, secure microcontrollers, cloud enclaves, medical devices, IoT gateways, domain-node routers, identity platforms, clearing systems, exchange systems, and resource systems.

In some embodiments, a product-service layer is organized into module families. A chip module family includes secure mailbox, PUFShield attestation, secure memory, nonce cache, monotonic counter, and signing functions. A record module family includes TimeChip records, signed asset-state records, audit pointers, rollback-boundary fields, and verification status codes.

A domain module family includes signed endpoint records, namespace provisioning records, root-domain identifiers, node slugs, reservation identifiers, idempotency keys, and provisioning state codes. A medical module family includes source authority checks, consent-state checks, temporal consistency checks, clinical relevance checks, physician_review states, emergency_only states, and medical rollback records.

A clearing and licensing module family includes license-state records, field-of-use restrictions, settlement receipt references, royalty-reference identifiers, rollback or clawback states, reverse-clear records, re-mint records, and re-index records. A resource module family includes energy-credit signals, environmental signals, resource-availability states, and Green Flux weighting values.

Each module family may be implemented or deployed independently while still using the common BEI trusted-execution path. This modular architecture permits a manufacturer, service provider, registrar, platform operator, or resource provider to adopt only the interface required for its product or service without changing the core BEIChip/BEILogic verification spine.

A licensing or clearing endpoint may verify a signed asset-state record, determine whether a license state is active, determine whether a field-of-use restriction permits a requested operation, generate a settlement receipt, process a royalty-reference record, and write a rollback, clawback, reverse-clear, re-mint, or re-index record when required by a verified rollback boundary.

In some embodiments, the signed BEI asset-state record or a derived license-state record includes a field-of-use restriction, license state, royalty-reference identifier, settlement receipt reference, rollback or clawback state, audit pointer, policy hash, and cryptographic signature.

A third-party chip vendor, medical platform, domain registrar, cloud service, identity platform, energy IoT platform, clearing system, or exchange system may implement only the interface required for its product domain while preserving compatibility with the signed BEI asset-state record format.

The pilot-ready embodiments include a BEI_MED medical event path, a BEI Node provisioning path, a Green Flux resource evidence path, a personal service receipt path, a family authorization path, a work event path, an education event path, a public-health priority path, and a domain-rooted endpoint path.

The system is suitable for staged deployment. A first stage may implement software and firmware interfaces on existing secure chips, TEEs, HSMs, TPM-backed services, or cloud enclaves. A second stage may implement dedicated BEI-compatible secure elements or IP blocks. A third stage may implement conformance tests, interoperable record formats, and domain-specific adapters. The technical utility of the system arises from the common signed asset-state record and rollback-boundary model, which enables different industries and endpoints to share a verifiable identity-time-policy-state result without requiring each endpoint to implement the entire trusted-execution stack.

### Additional Technical Support for Modular Implementations

This specification provides additional technical support for a Rollback Boundary modular implementation. The support includes at least field schemas, state-machine transitions, trusted-execution boundary descriptions, signed output records, audit logging, and bounded rollback logic.

This specification provides additional technical support for a BEI_MED medical modular implementation. The support includes at least field schemas, state-machine transitions, trusted-execution boundary descriptions, signed output records, audit logging, and bounded rollback logic.

This specification provides additional technical support for a BEI Node namespace modular implementation. The support includes at least field schemas, state-machine transitions, trusted-execution boundary descriptions, signed output records, audit logging, and bounded rollback logic.

This specification provides additional technical support for a Green Flux and IoT modular implementation. The support includes at least field schemas, state-machine transitions, trusted-execution boundary descriptions, signed output records, audit logging, and bounded rollback logic.

This specification provides additional technical support for a TimeChip and TimeFlux modular implementation. The support includes at least field schemas, state-machine transitions, trusted-execution boundary descriptions, signed output records, audit logging, and bounded rollback logic.

This specification provides additional technical support for a cloud enclave modular implementation. The support includes at least field schemas, state-machine transitions, trusted-execution boundary descriptions, signed output records, audit logging, and bounded rollback logic.

This specification provides additional technical support for a PUFShield device attestation modular implementation. The support includes at least field schemas, state-machine transitions, trusted-execution boundary descriptions, signed output records, audit logging, and bounded rollback logic.

This specification provides additional technical support for a signed asset-state protocol modular implementation. The support includes at least field schemas, state-machine transitions, trusted-execution boundary descriptions, signed output records, audit logging, and bounded rollback logic.

This specification provides additional technical support for a medical emergency disclosure modular implementation. The support includes at least field schemas, state-machine transitions, trusted-execution boundary descriptions, signed output records, audit logging, and bounded rollback logic.

This specification provides additional technical support for a domain-node asset plot modular implementation. The support includes at least field schemas, state-machine transitions, trusted-execution boundary descriptions, signed output records, audit logging, and bounded rollback logic.

### Conclusion

The disclosed BEIChip/BEILogic system provides a specific machine-executed pathway for transforming a behavioral event into a signed, auditable, and rollback-bounded asset-state record.

The system is implemented through concrete trusted-execution structures including secure memory, monotonic counter, nonce cache, policy hash register, state transition table, rollback boundary register, PUFShield attestation, cryptographic signing, and signature output serialization.

The system supports practical deployment in medical-health, domain-node provisioning, green-resource, IoT, family, work, service, education, supply-chain, and compliance environments without relying on uncontrolled abstract economic activity.

The embodiments described herein are illustrative and may be combined, divided, or implemented using equivalent trusted-execution structures, provided that the signed event, identity, time, policy, state-machine, audit, and rollback relationships described herein are preserved.

### FURTHER DETAILED EMBODIMENTS AND IMPLEMENTATION VARIANTS

### Embodiment Group 1: Personal Service Receipt

In an embodiment directed to personal service receipt, a caregiver, tutor, clinician, repair worker, or field technician performs a service and produces a verified service record. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For personal service receipt, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For personal service receipt, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The personal service receipt embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 2: Family Authorization

In an embodiment directed to family authorization, a family account holder delegates, revokes, restores, or limits access rights for a dependent, elder, or household resource. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For family authorization, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For family authorization, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For family authorization, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For family authorization, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For family authorization, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For family authorization, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For family authorization, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For family authorization, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For family authorization, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For family authorization, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For family authorization, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For family authorization, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For family authorization, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For family authorization, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For family authorization, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The family authorization embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 3: Medical Follow-Up

In an embodiment directed to medical follow-up, a licensed provider receives a patient event, applies a medical time tunnel, and emits a constrained admission result. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For medical follow-up, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For medical follow-up, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The medical follow-up embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 4: Emergency Disclosure

In an embodiment directed to emergency disclosure, an emergency provider obtains a limited disclosure state while an audit pointer and expiration window remain attached. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For emergency disclosure, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For emergency disclosure, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The emergency disclosure embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 5: Domain-Node Activation

In an embodiment directed to domain-node activation, a root domain and slug are converted into a signed endpoint through the namespace provisioning state machine. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For domain-node activation, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For domain-node activation, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The domain-node activation embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 6: Wallet Endpoint

In an embodiment directed to wallet endpoint, a wallet endpoint receives a signed asset-state record and verifies the eligibility flags before downstream use. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For wallet endpoint, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For wallet endpoint, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The wallet endpoint embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 7: Iot Energy Meter

In an embodiment directed to IoT energy meter, an energy meter signs a Green Flux event and transmits a resource contribution signal to the trusted execution boundary. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For IoT energy meter, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For IoT energy meter, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The IoT energy meter embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 8: Clinical Sensor

In an embodiment directed to clinical sensor, a wearable or medical device sends a time-bounded sensor event for admission, quarantine, or physician review. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For clinical sensor, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For clinical sensor, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The clinical sensor embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 9: Supply-Chain Checkpoint

In an embodiment directed to supply-chain checkpoint, a shipment, custody, or resource event is signed at a field gateway and mapped to a domain-node asset plot. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For supply-chain checkpoint, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For supply-chain checkpoint, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The supply-chain checkpoint embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 10: Education Event

In an embodiment directed to education event, a course, credential, attendance, or learning event is bound to identity, time, and policy before certification. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For education event, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For education event, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For education event, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For education event, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For education event, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For education event, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For education event, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For education event, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For education event, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For education event, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For education event, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For education event, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For education event, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For education event, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For education event, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The education event embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 11: Work Event

In an embodiment directed to work event, a verified work interval or professional service record is transformed into a signed receipt with rollback boundary. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For work event, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For work event, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For work event, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For work event, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For work event, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For work event, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For work event, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For work event, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

For work event, the medical admission function may operate as follows. When the event is medical, the gate applies source authority, consent state, temporal consistency, duplicate risk, and clinical relevance checks. The implementation may use the same field families described above, including identity_ref, event_digest, trusted_time_ref, nonce, validity_window, policy_hash, timeflux_vector, rollback_boundary_ptr, audit_pointer, and signature.

For work event, the Green Flux weighting function may operate as follows. When the event includes an environmental or energy contribution, the contribution is serialized into a weighting factor without exposing unrelated user data. The implementation may use the same field families described above, including identity_ref, event_digest, trusted_time_ref, nonce, validity_window, policy_hash, timeflux_vector, rollback_boundary_ptr, audit_pointer, and signature.

For work event, the idempotency function may operate as follows. Duplicate submissions within the validity window return the existing record and do not create a second asset-state record. The implementation may use the same field families described above, including identity_ref, event_digest, trusted_time_ref, nonce, validity_window, policy_hash, timeflux_vector, rollback_boundary_ptr, audit_pointer, and signature.

For work event, the privacy minimization function may operate as follows. The system transmits references, hashes, flags, and signed state records rather than exposing the full underlying personal or medical data payload where not required. The implementation may use the same field families described above, including identity_ref, event_digest, trusted_time_ref, nonce, validity_window, policy_hash, timeflux_vector, rollback_boundary_ptr, audit_pointer, and signature.

For work event, the downstream independence function may operate as follows. A downstream system can verify the signed record without becoming a co-operator of the BEIChip trusted execution infrastructure. The implementation may use the same field families described above, including identity_ref, event_digest, trusted_time_ref, nonce, validity_window, policy_hash, timeflux_vector, rollback_boundary_ptr, audit_pointer, and signature.

For work event, the failure handling function may operate as follows. If a required validation fails, the system emits a denial, hold, quarantine, or rollback audit record rather than deleting the original evidence. The implementation may use the same field families described above, including identity_ref, event_digest, trusted_time_ref, nonce, validity_window, policy_hash, timeflux_vector, rollback_boundary_ptr, audit_pointer, and signature.

For work event, the subsystem extensibility function may operate as follows. The embodiment supports modular deployment of the relevant TimeChip, BEI_MED, BEI Node, Green Flux, rollback, or output protocol subsystem within the common BEIChip/BEILogic execution architecture. The implementation may use the same field families described above, including identity_ref, event_digest, trusted_time_ref, nonce, validity_window, policy_hash, timeflux_vector, rollback_boundary_ptr, audit_pointer, and signature.

The work event embodiment may be combined with one or more other embodiments described in this specification, including PUFShield attestation, BEI Node provisioning, Medical Admission Gate processing, Green Flux weighting, and bounded rollback. Such combinations preserve the ordered technical path from event capture to signed output and provide additional support for method, system, and apparatus implementations.

### Embodiment Group 12: Public-Health Priority

In an embodiment directed to public-health priority, a resource allocation event is evaluated using clinical-risk, jurisdiction, availability, and time-window factors. The embodiment remains within the same trusted-execution framework: an event envelope enters a chip-authenticated or hardware-backed boundary, identity and time are bound, a TimeChip is generated, BEILogic selects a state, and a signed asset-state record is emitted with rollback and audit fields.

For public-health priority, the input validation function may operate as follows. The event envelope is rejected unless the identity reference, endpoint hash, timestamp source, and policy identifier match the expected schema. The implementation may use the same field families described above, including identity_ref, event_digest, trusted_time_ref, nonce, validity_window, policy_hash, timeflux_vector, rollback_boundary_ptr, audit_pointer, and signature.

For public-health priority, the counter continuity function may operate as follows. The current monotonic counter value is recorded with the event so that replay, rollback tampering, or stale state submission can be detected. The implementation may use the same field families described above, including identity_ref, event_digest, trusted_time_ref, nonce, validity_window, policy_hash, timeflux_vector, rollback_boundary_ptr, audit_pointer, and signature.

For public-health priority, the policy binding function may operate as follows. The policy hash is included in the signed output to make each downstream action traceable to the policy container active at the decision time. The implementation may use the same field families described above, including identity_ref, event_digest, trusted_time_ref, nonce, validity_window, policy_hash, timeflux_vector, rollback_boundary_ptr, audit_pointer, and signature.

For public-health priority, the rollback control function may operate as follows. A rollback boundary pointer is written before the signed output leaves the trusted execution module, thereby preserving a precise correction state. The implementation may use the same field families described above, including identity_ref, event_digest, trusted_time_ref, nonce, validity_window, policy_hash, timeflux_vector, rollback_boundary_ptr, audit_pointer, and signature.

For public-health priority, the audit preservation function may operate as follows. The original event and any correction, freeze, clawback, reverse_clear, re-mint, or re-index action is stored through an append-only audit pointer. The implementation may use the same field families described above, including identity_ref, event_digest, trusted_time_ref, nonce, validity_window, policy_hash, timeflux_vector, rollback_boundary_ptr, audit_pointer, and signature.

For public-health priority, the state transition function may operate as follows. BEILogic selects an approve, hold, deny, freeze, revoke, remediate, rollback, or clawback state based on deterministic input conditions. The implementation may use the same field families described above, including identity_ref, event_digest, trusted_time_ref, nonce, validity_window, policy_hash, timeflux_vector, rollback_boundary_ptr, audit_pointer, and signature.

For public-health priority, the signature formation function may operate as follows. The signature output serializer signs the complete data structure, including eligibility flags, state code, counter value, rollback boundary, and audit pointer. The implementation may use the same field families described above, including identity_ref, event_digest, trusted_time_ref, nonce, validity_window, policy_hash, timeflux_vector, rollback_boundary_ptr, audit_pointer, and signature.

For public-health priority, the namespace coupling function may operate as follows. The signed endpoint resolver maps the domain-node asset plot to a chip-authenticated endpoint rather than to an unauthenticated URL. The implementation may use the same field families described above, including identity_ref, event_digest, trusted_time_ref, nonce, validity_window, policy_hash, timeflux_vector, rollback_boundary_ptr, audit_pointer, and signature.

The trusted execution boundary therefore functions as a technical choke point without requiring every downstream participant to perform the same operations. The disclosed architecture supports a single-entity apparatus claim, a single-system domain-node infrastructure claim, and a method claim performed within the trusted execution module, while permitting specialized subsystems to be deployed through the same trusted-execution interface.

The medical, namespace, and resource embodiments may share a common signed asset-state record format. A downstream system receiving the record need not know the full underlying behavioral data; it can verify the signature, monotonic counter continuity, rollback boundary field, policy hash, and eligibility flags, and can then accept, reject, hold, or request remediation according to its own policy.

This restored disclosure further clarifies that a BEIChip or BEILogic implementation may be deployed first in a limited pilot while preserving the same technical architecture for larger deployments. The pilot implementation still uses an identity anchor, event digest, trusted time reference, nonce cache, policy hash, state transition table, rollback boundary register, audit pointer, and signature output serializer.

### RESTORED CONTINUITY STATEMENT

The foregoing embodiments provide continuous written-description support for the same 20-claim structure without adding claim numbers, without creating multiple dependencies, and without adding internal commentary to the upload file.

The specification is intentionally detailed so that the independent claims and dependent claims are supported by concrete fields, states, modules, protocols, records, and examples, while future continuation filings can be drawn from the same disclosed subject matter.

The embodiments are illustrative and may be implemented separately or in combination using local hardware, hardware-backed software, cloud enclave, HSM, secure element, IoT gateway, medical device controller, domain-node router, or other trusted execution structures described herein.

### ROOTED CELLULAR MULTI-ENDPOINT DEPLOYMENT AND LOGIC-FOLDED TRUST ARCHITECTURE

In some embodiments, the BEIChip/BEILogic architecture is deployed across a rooted cellular multi-endpoint network. The network may include user endpoints, family endpoints, household endpoints, device endpoints, medical endpoints, educational endpoints, work-service endpoints, agricultural endpoints, energy endpoints, vehicle endpoints, domain-node endpoints, industry endpoints, regional endpoints, jurisdictional endpoints, public-service endpoints, and institutional endpoints.

Each endpoint may be uniquely associated with an identity anchor, a domain-node record, a signed policy container, a trusted-time reference, a resource-state reference, a jurisdictional or permission classification, and a signed BEI asset-state output. The endpoints may operate as distributed trusted behavioral-economic identity terminals while using a common BEIChip/BEILogic verification architecture.

In some embodiments, the endpoints form a rooted cellular topology including root nodes, family nodes, device nodes, industry nodes, resource nodes, regional nodes, jurisdictional nodes, and domain-node asset plots. A root node may maintain policy-container references, namespace references, audit references, or mapping-table updates, while a cell node may process local behavioral event envelopes and produce signed BEI asset-state records for downstream systems.

In some embodiments, the BEIChip/BEILogic architecture performs logic folding within a trusted execution path. Multiple verification layers, including identity-anchor verification, trusted-time validation, behavioral-event validation, signed policy-container verification, mapping-table evaluation, rollback-boundary determination, and signed asset-state generation, are executed as a coordinated BEILogic sequence.

The resulting TimeChip or signed BEI asset-state record may represent a folded trust payload that can be consumed by downstream minting, indexing, exchange, clearing, medical-admission, namespace-provisioning, compliance, licensing, or rollback systems without requiring each downstream system to independently repeat the entire verification sequence.

In some embodiments, static states and dynamic events are processed together by BEILogic. Static states may include identity state, domain-node state, resource state, policy state, entitlement state, credential state, permission state, and jurisdictional state. Dynamic events may include behavioral events, service events, medical events, energy events, education events, work events, transaction events, emergency events, provisioning events, or resource-contribution events. BEILogic converts the interaction between such static states and dynamic events into a signed BEI asset-state output.

The same trusted execution path may therefore be configured for different populations, endpoints, industries, resources, currencies, jurisdictions, and downstream systems without changing the underlying BEIChip/BEILogic verification architecture. A signed policy container and configurable mapping table may expand, reduce, localize, substitute, or update supported endpoint classes and industry adapters while preserving the same identity, time, behavior, policy, rollback, audit, and signature control path.

### ROOTED CELLULAR ENDPOINT CLASSES AND TERMINAL IMPLEMENTATIONS

In some embodiments, a user endpoint is implemented by a mobile device, smart card, secure wallet, wearable device, browser-bound authenticator, personal health device, or household terminal. The user endpoint may receive a behavioral event envelope, bind the event to an identity anchor and trusted-time reference, and request generation of a TimeChip or signed BEI asset-state record through the BEI Secure Mailbox interface.

In some embodiments, a family endpoint is configured to manage delegated permissions among household members, guardians, caregivers, physicians, educators, service providers, or emergency responders. The family endpoint may store a family authorization profile, consent state, emergency disclosure rule, resource eligibility flag, and rollback boundary for a signed asset-state record associated with a household or family group.

In some embodiments, a device endpoint is configured to represent an IoT meter, vehicle controller, energy device, agricultural sensor, medical sensor, industrial sensor, or domain-node router. The device endpoint may include a PUF-backed or key-backed device identity, secure counter, event buffer, resource-state input, and output serializer configured to produce signed records that can be verified by downstream systems without exposing all underlying raw sensor data.

In some embodiments, a medical endpoint represents a patient terminal, provider terminal, clinic endpoint, emergency-response endpoint, clinical trial endpoint, or medical resource node. The medical endpoint may translate vital sign data, medication data, treatment event data, follow-up data, emergency disclosure data, or consent-state data into a behavioral event envelope processed by the Medical Admission Gate.

In some embodiments, an industry endpoint represents a specialized adapter for education, work service, agriculture, finance, insurance, transportation, logistics, manufacturing, supply chain, energy, public health, government service, emergency response, cultural service, or digital property service. The industry endpoint converts a domain-specific event into a normalized behavioral event envelope and maps it to a signed policy container and mapping-table entry.

In some embodiments, a regional or jurisdictional endpoint represents a city, county, state, country, treaty region, regulatory zone, institution, public-service authority, or cross-border service domain. The endpoint may provide jurisdictional rule identifiers, compliance-state flags, localization parameters, public-health priority parameters, emergency authority flags, or permission classes to the BEILogic mapping table.

In some embodiments, a domain-node endpoint represents an application domain, identity domain, record domain, medical domain, emergency domain, exchange domain, clearing domain, minting domain, index domain, resource domain, or governance domain. The domain-node endpoint may publish a signed endpoint record that binds a namespace label, identity anchor, policy-container hash, TimeChip reference, asset-state record, rollback boundary, and audit pointer.

In some embodiments, endpoint classes are not fixed at manufacture. A signed policy container may add, remove, substitute, or localize endpoint classes by updating mapping-table entries, eligibility flags, adapter rules, or permission states. Such updates do not require a change to the underlying trusted execution module when the signed policy container satisfies the authenticity and version checks of BEILogic.

In some embodiments, a rooted cellular topology includes a root policy node, intermediate resource or jurisdiction nodes, and terminal endpoint cells. A terminal endpoint cell may perform local event capture and TimeChip generation, while a root or intermediate node may publish signed policy containers, mapping-table updates, audit checkpoints, or revocation information. Each cell may remain independently verifiable through its signed asset-state records.

In some embodiments, the rooted cellular topology reduces redundant downstream verification by enabling each endpoint cell to present a signed BEI asset-state record. A downstream system may verify the signature, policy hash, TimeChip reference, rollback boundary, and audit pointer without repeating the entire identity, time, behavior, resource, policy, and mapping verification sequence.

### LOGIC-FOLDED PAYLOAD AND MULTI-SYSTEM OUTPUT IMPLEMENTATIONS

In some embodiments, a TimeChip functions as a logic-folded payload in which identity state, time state, event state, policy state, mapping state, rollback state, and audit state are represented by fields or references within a single signed structure. The folded payload permits a receiving system to verify the trust basis of an event through compact field verification rather than through reconstruction of all upstream events.

In some embodiments, a signed BEI asset-state record functions as a multi-system output object. The record may be consumed by a minting endpoint, index endpoint, exchange endpoint, clearing endpoint, compliance endpoint, medical endpoint, namespace provisioning endpoint, resource endpoint, or licensing endpoint. Each downstream endpoint may use a different subset of fields while preserving the same signature and audit chain.

In some embodiments, BEILogic folds multiple decision domains into a single deterministic state machine. Identity validity, time validity, event validity, policy validity, mapping validity, resource availability, compliance state, rollback eligibility, and downstream eligibility may be evaluated in an ordered sequence, and the resulting state-transition code may be stored in the signed BEI asset-state record.

In some embodiments, a downstream system may rely on an eligibility flag without receiving all original personal, medical, financial, sensor, or resource data. For example, a minting endpoint may read mint_eligible, a clearing endpoint may read license_active and settlement_state, a medical endpoint may read emergency_only or physician_review, and an index endpoint may read index_eligible and audit_pointer.

In some embodiments, the logic-folded payload permits privacy minimization and system acceleration. The trusted execution module may disclose hashes, references, status flags, and signatures instead of full raw evidence. The output record therefore provides a verifiable state while reducing repeated transmission of sensitive source data across multiple industries or downstream systems.

In some embodiments, a rollback boundary is folded into the TimeChip and signed BEI asset-state record. The rollback boundary may identify the earliest state to which a correction, clawback, reverse-clear, re-mint, or re-index operation may be applied. The original record is preserved in an append-only audit structure, while the correction creates a new signed record with a new state-transition code.

In some embodiments, the same event may be processed by different industry adapters while preserving a common trust structure. A medical adapter, energy adapter, education adapter, work-service adapter, agricultural adapter, supply-chain adapter, financial adapter, public-service adapter, and domain-node adapter may each translate local event data into the shared behavioral event envelope format.

In some embodiments, industry adapters are bound to signed policy containers. A signed policy container may specify event schema, permitted data sources, required consent state, resource class, jurisdictional rule, mapping-table entry, downstream endpoint, rollback rule, and audit requirement for the adapter. BEILogic may reject an event when the adapter output does not match the active policy container.

In some embodiments, BEI-compatible endpoint terminals may be implemented by existing chips, secure elements, trusted execution environments, HSMs, TPM-backed services, secure microcontrollers, cloud enclaves, or software-defined BEPU modules. The common requirement is that the endpoint terminal can submit or process the event envelope, validate policy, bind trusted time, and output or verify a signed BEI asset-state record.

In some embodiments, a chipset manufacturer may implement only a portion of the architecture, such as a secure mailbox, PUFShield attestation routine, nonce cache, monotonic counter, protected key slot, or output serializer. Another system may implement BEI Node provisioning, BEI_MED admission, Green Flux weighting, clearing, indexing, exchange, or licensing, provided that the signed records preserve the same field relationships.

In some embodiments, the architecture permits a product-service layer to be built above existing hardware without requiring replacement of all downstream systems. A chip, TEE application, HSM service, secure gateway, domain-node router, medical controller, or IoT device may expose BEI-compatible commands while downstream services consume signed records according to their own industry requirements.

In some embodiments, the BEI Secure Mailbox interface may receive a command identifier, session identifier, identity reference, event digest, policy hash, nonce, trusted-time reference, endpoint reference, and optional resource-state reference. The trusted execution module may return a response containing a decision code, TimeChip reference, asset-state identifier, rollback boundary, audit pointer, attestation report, or signed output record.

In some embodiments, a BEI-compatible terminal may support conformance checking by processing known event envelopes and producing expected TimeChip, decision code, signature, rollback boundary, or audit pointer values. Such conformance checking may be used to verify that different hardware, firmware, cloud, or device implementations produce interoperable records from the same policy and event inputs.

In some embodiments, the architecture may be applied to large endpoint populations by assigning endpoint-specific identity anchors, namespace labels, policy-container versions, and audit paths. Endpoint populations may be organized by person, family, household, institution, device class, industry, resource class, geographic region, jurisdiction, or service domain while preserving a common BEIChip/BEILogic verification pathway.

In some embodiments, a mapping-table update may enable a new industry category or endpoint class without changing the TimeChip field structure, signed asset-state record schema, rollback-boundary logic, PUFShield attestation method, or output serializer. This permits broad multi-industry deployment while keeping the trusted execution core stable and verifiable.

### MULTI-ENDPOINT PRODUCT-SERVICE OPERATIONAL EXAMPLES

In one user-endpoint embodiment, a mobile device receives a work-service event from an application, obtains a trusted-time reference from a secure clock, submits an event digest through the BEI Secure Mailbox interface, and receives a signed BEI asset-state record indicating whether the event is eligible for authorization, indexing, clearing, or bounded correction.

In one family-endpoint embodiment, a household terminal receives a caregiver visit record, verifies a family authorization profile, binds the visit time to a trusted time anchor, produces a TimeChip, and stores a signed service receipt with a rollback boundary permitting later correction if the caregiver, patient, or authorized family member identifies an error.

In one educational endpoint embodiment, a school, training provider, or online learning terminal converts attendance, assessment, credential, or tutoring events into behavioral event envelopes. A signed policy container may define required evidence, instructor role, jurisdictional rule, privacy limit, and downstream eligibility for credential verification or learning-resource allocation.

In one agricultural endpoint embodiment, a farm sensor, irrigation meter, field device, commodity checkpoint, or agricultural service terminal reports resource signals, work events, production evidence, or environmental measurements. BEILogic may map those inputs to resource classes, supply-chain classes, policy rules, and signed asset-state outputs usable by resource, insurance, or supply-chain systems.

In one energy endpoint embodiment, a solar inverter, vehicle charger, home energy meter, battery controller, or thermoelectric recovery device provides sensor-attested energy contribution data. The Green Flux module may incorporate the signal into a TimeFlux weighting vector while the trusted execution module signs a resource evidence record with a rollback boundary and audit pointer.

In one public-service endpoint embodiment, a government service terminal, emergency-response terminal, public-health terminal, or municipal resource node receives a request event and validates identity class, jurisdictional authority, public-service rule, emergency state, resource availability, and audit requirement before producing a signed BEI asset-state record.

In one supply-chain endpoint embodiment, a warehouse scanner, logistics gateway, transport controller, customs checkpoint, manufacturing station, or retail terminal converts a checkpoint event into a behavioral event envelope. The signed asset-state record may include endpoint hash, supply-chain resource class, timestamp, nonce, policy hash, and audit pointer for later verification.

In one financial or clearing endpoint embodiment, a payment gateway, settlement connector, account node, or asset-transfer service receives a signed BEI asset-state record and verifies eligibility flags, policy hash, rollback boundary, and audit pointer before generating a settlement receipt or license-state record. The clearing endpoint need not perform the original identity and TimeChip generation operations.

In one domain endpoint embodiment, a root domain, application domain, subdomain, or namespace label is associated with a signed endpoint record. A provisioning request may reserve a slug, verify order metadata, transition through queued and active states, and emit a signed provisioning record with an idempotency key and rollback log.

In one medical endpoint embodiment, a clinic terminal, emergency terminal, wearable sensor, patient application, or provider portal processes a medical event envelope. The Medical Admission Gate may evaluate source authority, consent state, temporal consistency, clinical relevance, duplicate risk, anomaly status, and emergency condition before outputting accepted, physician_review, emergency_only, research_only, quarantine, or rollback states.

In one identity endpoint embodiment, a ReadName vault, BEIDID endpoint, credential manager, or biometric authenticator provides an identity-anchor reference, revocation state, recovery state, delegation state, or privacy-preserving commitment. The BEIChip/BEILogic path may bind such identity information to a TimeChip and signed asset-state output without exposing unnecessary underlying credentials.

In one record endpoint embodiment, a BEIRecord-like audit service stores append-only references to signed asset-state records, rollback records, clawback records, remediation records, provisioning records, settlement receipts, medical admission records, or resource evidence records. A downstream system may later verify the audit pointer and signature without receiving the full raw evidence payload.

In one exchange endpoint embodiment, a BEIGX-like service receives an asset-state record, verifies exchange_eligible or license_active flags, checks rollback boundary status, and routes the record into transfer, licensing, clearing, or settlement workflows. The exchange endpoint may reject records whose audit pointer, policy hash, or rollback boundary is invalid.

In one clearing endpoint embodiment, an ATMS-like service verifies asset-time-monetary state by reading the signed asset-state record, decision code, eligibility flags, license state, field-of-use restriction, royalty reference, and rollback or clawback fields. The clearing endpoint may generate a settlement receipt linked to the originating asset-state record by a shared digest reference.

In one index endpoint embodiment, a BEIIndex or BIGindex service receives signed records from multiple endpoint classes and computes index eligibility, valuation state, resource category, behavioral class, or public-health priority based on verified fields rather than unverified narratives. A later rollback, re-index, or remediation record may update the index state while preserving the prior audit chain.

In one minting endpoint embodiment, a BEIMint-like service receives a signed asset-state record and verifies a mint_eligible flag, TimeChip reference, policy hash, rollback boundary, and audit pointer before issuing a minting record or rejecting the request. If a later rollback occurs, a re-mint or clawback state may be emitted according to the signed policy container.

In one standards-compatible implementation, the same endpoint patterns may be realized through a GlobalPlatform-compatible trusted application, TPM-backed service, HSM-backed service, secure microcontroller firmware, FIDO or WebAuthn identity input, cloud confidential-computing enclave, PUF-backed secure element, or software-defined BEPU module.

In one population-scale implementation, endpoint cells may be registered, updated, suspended, revoked, remediated, or migrated without changing the core TimeChip schema or signed asset-state record format. This permits the trusted execution architecture to support large numbers of persons, families, devices, resources, industries, regions, and jurisdictions while maintaining a consistent verification pathway.

What is claimed is:

1. A method performed within a hardware security module (HSM) or trusted execution environment (TEE) comprising a monotonic counter, a PUF root-of-trust circuit, and a hardware-isolated key slot, the method comprising: receiving a behavioral event envelope associated with an identity subject; binding the behavioral event envelope to a trusted time anchor and recording a current monotonic counter value associated with the trusted time anchor; generating a nonce-protected time-value fragment comprising an event digest, an identity-anchor reference, a trusted-time reference, a nonce, a validity window, a policy-defined TimeFlux weighting vector, and a rollback boundary pointer; executing BEILogic within the TEE or HSM, wherein execution is attested by a PUFShield attestation report generated from a PUF challenge-response operation; applying anti-replay, proof-gate, policy-gate, compliance-gate, and mapping checks, wherein the anti-replay check verifies that the nonce has not appeared in a nonce cache within the validity window; and outputting a cryptographically signed BEI asset-state record comprising the monotonic counter value, a rollback boundary field, eligibility flags, a BEILogic decision code, an audit pointer, and an ECDSA or EdDSA signature over all record fields.

2. A chip-authenticated domain-node network security infrastructure system, comprising: a plurality of domain-node asset plots including user endpoints, family endpoints, household endpoints, device endpoints, medical endpoints, educational endpoints, work-service endpoints, agricultural endpoints, energy endpoints, vehicle endpoints, resource endpoints, industry endpoints, regional endpoints, jurisdictional endpoints, root domains, subdomains, ReadName nodes, wallet nodes, account nodes, and asset-package nodes, each associated with a signed endpoint record comprising a domain identifier, an identity-anchor hash, a policy-container reference, a validity timestamp, a nonce, and a cryptographic signature over all preceding fields; a BEI Access Point associated with at least one domain-node asset plot; a chip-authentication module configured to verify the identity of each access endpoint by validating the signed endpoint record against a PUFShield-attested device certificate; a signed endpoint resolver configured to bind an endpoint, identity anchor, policy container, and asset-state record; a namespace provisioning state machine configured to process states comprising reserved, queued, running, site_created, initialized, active, failed, retry_wait, cancelled, and rolled_back, and to emit a signed provisioning record on each transition; a memory-mapped configurable mapping table stored in non-transitory memory, encoding mappings among identity classes, industry categories, resource classes, jurisdiction rules, and permission states; an authorization ledger storing tamper-evident signed access, license, transfer, and rollback state records; and an output interface to at least one downstream system.

3. A BEI behavioral-economic identity hardware-software chip apparatus, comprising: an identity-binding module configured to bind an identity subject to a cryptographic identity anchor; a secure memory region storing, in non-transitory memory accessible to a trusted execution module, a cryptographic identity anchor, a monotonic counter, a nonce cache, a policy hash register, a state transition table, and a rollback boundary register; a PUF root-of-trust circuit configured to derive a device-unique key from silicon manufacturing variations and to generate a PUFShield attestation report comprising device_id, monotonic counter value, policy version, and timestamp; a behavioral-event input module comprising an event input buffer configured to receive and queue behavioral event envelopes; the trusted execution module comprising at least one of a secure element, trusted execution environment, hardware security module, trusted platform module, secure enclave, PUFShield circuit, mobile wallet chip, IoT chip, cloud enclave, BEPU, or software-defined chip; a BEILogic engine configured to execute the state transition table against inputs from the behavioral-event input module, the monotonic counter, the nonce cache, the policy hash register, and the rollback boundary register; a cryptographic signing module configured to sign a BEI asset-state record using the device-unique key derived by the PUF root-of-trust circuit; and a signature output serializer configured to format and transmit the signed BEI asset-state record to minting, indexing, exchange, clearing, or rollback systems.

4. The method of claim 1, wherein the trusted time anchor comprises at least one of a secure clock, a network time protocol source, a blockchain timestamp, a Time Tape entry, a lifecycle event time, a medical event time, a treatment episode, a medication course, a disease episode, a clinical-trial period, an emergency window, a work event time, an educational event time, or a Time of Time reference, and wherein the trusted time anchor is bound to the monotonic counter value at the time of binding, such that any tampering with the time reference is detectable through counter verification.

5. The method of claim 1, wherein the time-value fragment is a TimeChip record comprising fields including identity_ref [SHA-256 of identity anchor], event_digest [SHA-256 of behavioral event envelope], trusted_time_ref [Unix epoch and NTP source identifier], nonce [CSPRNG-generated, 128-bit, single-use], validity_window [start_epoch and duration_seconds], policy_hash [SHA-256 of active policy container], timeflux_vector [policy-defined weighting array], rollback_boundary_ptr [pointer to last verified rollback boundary record], audit_pointer [pointer to append-only audit log entry], and a cryptographic signature over all preceding fields.

6. The method of claim 1, wherein the BEILogic applies a TRAM weighting model comprising at least one of behavior energy, event circulation, transfer count, node heat, gain coefficient, historical density, energy credit, medical-risk weight, resource-availability weight, or policy-defined amplification factor, and wherein the TimeFlux weighting vector is computed as TFV=sum(e_i x w_i x tau_i), where e_i is an event category weight, w_i is a behavioral class weight, and tau_i is a policy-defined time-decay factor.

7. The method of claim 1, wherein the anti-replay check uses at least one of a nonce, a validity window, a sequence counter, an endpoint hash, a policy version, a signature timestamp, an idempotency key, a reservation freshness window, or a duplicate-risk score, wherein the nonce is verified against a hardware-resident nonce cache with TTL equal to the validity window duration, and wherein the idempotency key is computed as HMAC-SHA256(K_session, identity_ref concatenated with event_digest concatenated with timestamp_floor), ensuring that duplicate submissions of the same behavioral event within the validity window return the existing record without duplicate processing.

8. The method of claim 1, wherein the signed BEI asset-state record comprises asset_state_id [UUID v4], identity_ref, domain_ref, timechip_id, beilogic_decision [enum: 0×01=APPROVE, 0×02=DENY, 0×03=HOLD, 0×04=FREEZE, 0×05=REVOKE, 0×06=REMEDIATE, 0×07=ROLLBACK, 0×08=CLAWBACK], eligibility_flags [mint_eligible, exchange_eligible, index_eligible, license_active], rollback_boundary [monotonic counter value at issuance], audit_pointer, policy_hash, and a cryptographic signature over all preceding fields.

9. The infrastructure system of claim 2, wherein the domain-node asset plot comprises at least one of a ReadName node, a DomainToken record, a sub-domain node, a supply-chain node, a resource node, a medical-health terminal, a field-of-use licensing node, an ATMS clearing node, or a BEI Node provisioning record, and wherein each domain-node asset plot is associated with a signed endpoint record and accessible only through a chip-authenticated BEI Access Point.

10. The infrastructure system of claim 2, wherein the configurable mapping table comprises a need-industry-resource-regulation matrix configured to map a plurality of need categories, industry categories, resource classes, currency classes, medical resource categories, jurisdiction rules, clinical-risk classes, public-health priorities, charity eligibility states, identity classes, endpoint classes, family classes, institutional classes, compliance states, permission states, rollback states, and downstream eligibility states, and wherein the mapping table is stored in non-transitory memory and may be updated via a signed policy container without requiring a system restart.

11. The infrastructure system of claim 2, wherein the system includes a fusion module configured to compute a policy-defined weighting vector from environmental signals, behavioral signals, resource signals, clinical-evidence signals, device signals, energy signals, household signals, educational signals, work-service signals, agricultural signals, vehicle signals, regional signals, jurisdictional signals, time-window signals, industry classifications, identity classifications, and medical-resource availability states, and wherein the weighting vector is applied by BEILogic to determine the behavioral economic identity asset-state decision.

12. The infrastructure system of claim 2, wherein the BEI Access Point generates a transaction-ready namespace provisioning record comprising root_domain_id [SHA-256 of root domain], node_slug [URL-safe identifier], reservation_id [UUID v4], order_id [UUID v4], user_id [SHA-256 of identity anchor], state_code [enum], idempotency_key [HMAC-SHA256 of domain, slug, and timestamp], endpoint_hash [SHA-256 of provisioned endpoint URL], policy_container_hash, and a cryptographic signature over all preceding fields.

13. The infrastructure system of claim 2, wherein the namespace provisioning state machine processes the states reserved, queued, running, site_created, initialized, active, failed, retry_wait, cancelled, and rolled_back, wherein each state transition emits a signed provisioning record, and wherein the rolled_back state reverts to the last active or initialized state recorded in the append-only provisioning log.

14. The infrastructure system of claim 2, wherein the output interface supports at least one of BEIMint issuance, TimeCurrency issuance, BEIIndex valuation, BEIGX exchange, ATMS clearing, BIGX settlement, BIGindex feedback, medical resource clearing, cross-chain bridge synchronization, or governance update, and wherein the interface transmits the signed BEI asset-state record to the downstream system without requiring the downstream system to be a co-operator of the domain-node infrastructure.

15. The apparatus of claim 3, wherein the trusted execution module includes a PUFShield security layer comprising a PUF root-of-trust, programmable noise injection for power and electromagnetic side-channel masking, protocol-agility control, honeypot endpoint simulation, anomaly detection and quarantine, checkpoint rollback, and tamper-evident security-event logging, and wherein the PUF root-of-trust derives the device-unique key K_device from silicon manufacturing variations on each power-up without storing K_device in non-volatile memory.

16. The apparatus of claim 3, wherein the identity-binding module comprises at least one of a ReadName vault, a protocol-native biomedical identity record, a sharded credential store, a multi-signature key manager, a biometric liveness verifier, a recovery state, a revocation state, a delegation state, a family authorization profile, an emergency disclosure permission, or a privacy-preserving commitment scheme.

17. The apparatus of claim 3, wherein the behavioral-event input module receives input from at least one of wearable sensors, mobile devices, IoT devices, browser events, medical systems, educational systems, work systems, household-service systems, agricultural systems, vehicle systems, supply-chain systems, resource meters, energy meters, domain-node endpoints, jurisdictional endpoints, or namespace provisioning events.

18. The apparatus of claim 3, wherein the BEILogic state machine includes approve, deny, hold, freeze, revoke, remediate, admit, quarantine, physician_review, emergency_disclose, rollback, clawback, reverse_clear, re-mint, and re-index states; wherein rollback comprises reverting to a rollback_boundary_register value upon a triggering condition; wherein clawback comprises clearing eligibility flags set after a rollback boundary and emitting a clawback record; wherein reverse_clear comprises reversing a clearing transaction and emitting a reversal record; wherein re-mint comprises re-issuing a minting record after remediation; and wherein re-index comprises re-submitting a record to BEIIndex after rollback or correction.

19. The apparatus of claim 3, further comprising a Green Flux module configured to receive an energy-credit signal, a thermoelectric recovery signal, a power-state signal, an environmental signal, or a sensor-attested energy contribution and to apply the signal to a policy-defined weighting rule within the TimeFlux vector computation.

20. The apparatus of claim 3, wherein the signature output serializer formats and transmits the signed BEI asset-state record using at least one of a BEI endpoint protocol, a BEI record format, a BEI asset-state format, a BEI authorization protocol, a BEI index protocol, a BEI exchange protocol, a BEI mint protocol, a BEI medical-health protocol, a BEI namespace provisioning protocol, a BEI resource protocol, a BEI industry-adapter protocol, a BEI rollback protocol, or a BEI compliance protocol, and wherein the protocol is defined by a policy container and may be updated without hardware modification.
